(19) United States
(12) Patent Application Publication
(10) Pub. No.: US 2018/0375858 A1
(43) Pub. Date: Dec. 27, 2018

(54) SYSTEM, IMAGE PROCESSING APPARATUS, AND METHOD OF AUTHENTICATION

(71) Applicant: Genki WATANABE, Tokyo (JP)

(72) Inventor: Genki WATANABE, Tokyo (JP)

(21) Appl. No.: 16/013,984

(22) Filed: Jun. 21, 2018

(30) Foreign Application Priority Data
Jun. 22, 2017 (JP) 2017-122625

(51) Int. Cl. H04L 29/06; H04W 12/06; H04W 52/02; G06K 9/00; H04W 4/80

(52) U.S. Cl. CPC H04L 63/0861; H04L 63/0853; H04W 12/06; H04W 52/0209; H04W 88/02; G06K 9/00892; H04W 4/80; G06K 2009/00932; G06K 9/00087

(57) ABSTRACT

A system includes a communication device to perform wireless communication with a terminal carried by a user, a biometric authentication device to acquire biometric information of the user, an information processing apparatus, connected to the communication device and the biometric authentication device, including circuitry to activate the information processing apparatus and the biometric authentication device in response to a detection of the terminal by the communication device during a power saving mode, perform wireless authentication processing for the user based on authentication information received by the communication device from the terminal, perform the biometric authentication processing for the user using first biometric feature information of the user registered in advance, and second biometric feature information of the user acquired by the biometric authentication device, and allow the user to use an execution apparatus in response to authentication of the user by the wireless authentication processing and the biometric authentication processing.

### CROSS-REFERENCE TO RELATED APPLICATION

This application claims priority pursuant to 35 U.S.C. § 119(a) to Japanese Patent Application No. 2017-122625, filed on Jun. 22, 2017 in the Japan Patent Office, the disclosure of which is incorporated by reference herein in its entirety.

### BACKGROUND

### Technical Field

This disclosure relates to a system, an image processing apparatus, and a method of authentication.

### Background Art

Typically, users of apparatuses are authenticated using a two-factor authentication method, in which a user is authenticated by a combination of two types of authentication methods such as combinations of any two types of authentication methods selected from a method of authenticating based on knowledge of user (knowledge authentication method), a method of authenticating based on personal property (personal property authentication method), and a method of authenticating based on biological characteristics of user (biometrics authentication method).

For example, image forming apparatuses authenticate a user using a combination of wireless authentication using a wireless tag carried by a user, which is an example of personal property identification, and an image authentication using an image of a user face, which is an example of biometric authentication.

By performing the two-factor authentication processing combining the wireless authentication and image authentication, the accuracy of user authentication can be improved and spoofing can be prevented.

However, the two-factor authentication processing requires the two authentication processing so that the user authentication may become complicated, or waiting time required for the authentication processing may increase, resulting in a decrease in operability.

### SUMMARY

As one aspect of the present invention, a system is devised. The system includes a wireless communication device to perform wireless communication with a wireless terminal carried by a user, a biometric authentication device to acquire biometric information of the user carrying the wireless terminal to perform a biometric authentication of the user, an information processing apparatus, connected to the wireless communication device and the biometric authentication device, including circuitry to shift the information processing apparatus and the biometric authentication device each from a normal mode in which one or more processing are executable, to a power saving mode in which power consumption is set lower than power consumption during the normal mode, when a mode shifting condition is satisfied, activate the information processing apparatus and the biometric authentication device in response to a detection of the wireless terminal by the wireless communication performed between the wireless communication device and the wireless terminal during the power saving mode, perform wireless authentication processing for the user carrying the wireless terminal based on authentication information received by the wireless communication device from the wireless terminal using the wireless communication, perform the biometric authentication processing for the user using first biometric feature information of the user registered in advance, and second biometric feature information of the user acquired by using the biometric authentication device in response to authentication of the wireless authentication of the user, and allow the user to use an execution apparatus disposed in the system in response to authentication of the user by the wireless authentication processing and the biometric authentication processing.

As another aspect of the present invention, an image processing apparatus is devised. The image processing apparatus includes a wireless communication device to perform wireless communication with a wireless terminal carried by a user, a biometric authentication device to acquire biometric information of the user carrying the wireless terminal to perform biometric authentication of the user, an execution apparatus to execute image processing, and an operation apparatus connected to the wireless communication device, the biometric authentication device, and the execution apparatus. The operation apparatus includes circuitry to activate the operation apparatus and the biometric authentication device in response to a detection of the wireless terminal by the wireless communication performed between the wireless communication device and the wireless terminal during a power saving mode, power consumption during the power saving mode being set lower than power consumption during a normal mode that one or more processing are executable, perform wireless authentication processing for the user carrying the wireless terminal based on authentication information received by the wireless communication device from the wireless terminal using the wireless communication, perform the biometric authentication processing for the user using first biometric feature information of the user registered in advance, and second biometric feature information of the user acquired by using the biometric authentication device in response to authentication of the wireless authentication of the user, and allow the user to use the execution apparatus in response to authentication of the user by the wireless authentication processing and the biometric authentication processing.

As another aspect of the present invention, A method of controlling an authentication of a user in a system including a wireless communication device to perform wireless communication with a wireless terminal carried by the user, and a biometric authentication device to acquire biometric information of the user carrying the wireless terminal to perform biometric authentication of the user is devised. The method includes activating the biometric authentication device in response to a detection of the wireless terminal by the wireless communication performed between the wireless communication device and the wireless terminal during a power saving mode, power consumption during the power saving mode being set lower than power consumption during a normal mode that one or more processing are executable, performing wireless authentication processing for the user carrying the wireless terminal based on authentication information received by the wireless communication device from the wireless terminal using the wireless communication, performing the biometric authentication processing for the user using first biometric feature information of the user registered in advance, and second biometric feature information of the user acquired by using the biometric authentication device in response to authentication of the wireless authentication of the user, and allowing the user to use an execution apparatus disposed in the system in response to authentication of the user by the wireless authentication processing and the biometric authentication processing.

### BRIEF DESCRIPTION OF THE DRAWINGS

A more complete appreciation of the description and many of the attendant advantages and features thereof can be readily acquired and understood from the following detailed description with reference to the accompanying drawings, wherein:

FIG. 1 illustrates an example of a system configuration of an information processing system of an embodiment;

FIG. 2 illustrates an example of a hardware block diagram of an image forming apparatus used in the information processing system of FIG. 1;

FIG. 3 illustrates an example of a functional block diagram of the image forming apparatus of FIG. 2.

FIG. 4 illustrates an example of user information used in the embodiment.

FIG. 5 is an example of a flowchart illustrating the steps of authentication processing of a first embodiment;

FIG. 6 is an example of a flowchart illustrating the steps of a wireless authentication processing of the first embodiment;

FIG. 7 is an example of a flowchart illustrating the steps of a fingerprint authentication processing of the first embodiment;

FIG. 8 is an example of a sequence diagram illustrating a transition or shifting process to a power saving mode in the first embodiment;

FIGS. 9A and 9B are an example of a sequence diagram illustrating an authentication processing from a power saving mode in the first embodiment;

FIG. 10 is an example of a sequence diagram illustrating a process of returning from a power saving mode of a main unit in the first embodiment;

FIG. 11 is an example of a flowchart illustrating the steps of authentication processing of a second embodiment;

FIGS. 12A, 12B, 12C, 12D, and 12E are examples of tables describing relationships between radio wave intensity and wireless authentication in the second embodiment;

FIG. 13 is an example of a flowchart illustrating the steps of a process of cancelling wireless authentication of the second embodiment;

FIGS. 14A, 14B, 14C, 14D, and 14E are another example of tables describing relationships between radio wave intensity and wireless authentication of the second embodiment;

FIGS. 15A and 15B are an example of a flowchart illustrating the steps of authentication processing of a third embodiment;

FIG. 16 is an example of a flowchart illustrating the steps of authentication processing of a variant example;

FIG. 17A illustrates examples of images of a display screen used in one or more embodiments;

FIG. 17B illustrates another example of images of a display screen used in one or more embodiments;

FIG. 18 is an example of a flowchart illustrating the steps of authentication processing of another variant example;

FIG. 19 is an example of a flowchart illustrating the steps of authentication processing of still another variant example;

FIG. 20 is an example of log information in one or more embodiments; and

FIG. 21 illustrates an example of a software configuration of the image forming apparatus of one or more embodiments.

The accompanying drawings are intended to depict embodiments of the present invention and should not be interpreted to limit the scope thereof The accompanying drawings are not to be considered as drawn to scale unless explicitly noted.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a description is given of one or more embodiments of the present invention with reference to the accompanying drawings.

### System Configuration:

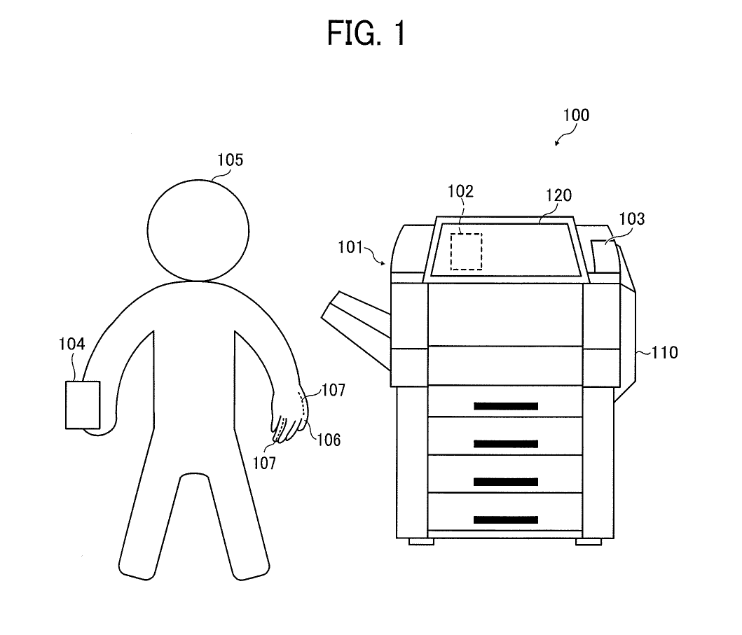

FIG. 1 illustrates an example of a system configuration of an information processing system 100 of an embodiment. As illustrated in FIG. 1, the information processing system 100 includes, for example, an image forming apparatus 101, a wireless communication device 102, and a fingerprint authentication device 103. The wireless communication device 102 and the fingerprint authentication device 103 can be integrated in the image forming apparatus 101, or can be separately disposed and connected to the image forming apparatus 101 wirelessly and/or by wire.

The image forming apparatus 101 is an example of electronic devices or apparatuses, such as a copier, a printer, and a multifunctional peripheral (MFP) having various functions such as a printing function, a scanner function, a copy function, and a facsimile function. The image forming apparatus 101 is also an example of an image processing apparatuses in this description.

The image forming apparatus 101 includes, for example, a main unit 110 (or execution apparatus, first apparatus, first device) used for performing image processing, and an operation unit 120 (or operation apparatus, second apparatus, second device) connected to the main unit 110 and receives an operation of a user 105. The operation unit 120 is used to operate the main unit 110.

For example, the wireless communication device 102 and the fingerprint authentication device 103 are connected to the operation unit 120 wirelessly or by wire. In an example illustrated in FIG. 1, the wireless communication device 102 is disposed, for example, inside the operation unit 120 (see dot line in FIG. 1), and the fingerprint authentication device 103 is disposed, for example, outside the operation unit 120.

The operation unit 120, which is an example of information processing apparatuses, employs a general computer configuration, and can be operated using a power-saving operating system (OS), such as Android (registered trademark), but not limited thereto.

The wireless communication device 102 is a wireless-operation module, a wireless operation apparatus, a wireless operation circuit, or a semiconductor device that communicates with a wireless terminal 104 held or carried by the user 105 using short-range wireless communication, such as Bluetooth (registered trademark) Low Energy (BLE), but not limited thereto.

Further, the wireless communication device 102 may use wireless communication other than BLE, such as a wireless local area network (LAN). In this description, it is assumed that the wireless communication device 102 is a BLE communication device that uses short-range wireless communication using BLE (hereinafter, BLE communication).

The fingerprint authentication device 103 is a fingerprint authentication device, a fingerprint authentication unit, a fingerprint scanning unit, or a fingerprint reading unit that acquires fingerprint information of the user 105 when the user 105 contacts his or her finger(s) 106 on a sensor of the fingerprint authentication device 103 or when the user 105 approaches his or her finger(s) 106 proximity of the sensor of the fingerprint authentication device 103, in which known contact type fingerprint sensors or known non-contact type fingerprint sensor can be used as the sensor of the fingerprint authentication device 103. The fingerprint authentication device 103 is an example of a biometric authentication device for acquiring biometric information used for the biometric authentication of the user 105, and the fingerprint information is an example of biometric information used for the biometric authentication of the user 105.

Further, the biometric authentication device may be, for example, a vein authentication device for acquiring vein information used for vein authentication of the user 105. The information of vein 107 of the user 105 can be acquired using known contact type vein sensors or known non-contact type vein sensors as a sensor of the vein authentication device when the user 105 contacts, for example, the finger 106 or a hand palm of the user 105 on the sensor of the vein authentication device or when the user 105 approaches the finger 106 or the hand palm proximity to the sensor of the vein authentication device without contacting the finger 106 or the hand palm of the user 105 on the sensor of the vein authentication device. In this description, it is assumed that the fingerprint authentication device 103 is used as the biometric authentication device, and the finger 6 and the hand palm of the user 105 are described as examples of parts of body of the user 105.

The wireless terminal 104 is a terminal device, such as a smart phone, and a wearable terminal held or carried by the user 105, which can communicate with other devices or apparatuses using a wireless communication, such as the BLE communication.

In the above configuration, the image forming apparatus 101 has a power saving function. For example, when the image forming apparatus 101 is not being used for a pre-set period of time or more, the image forming apparatus 101 is shifted to a power saving mode that consumes less power than a normal mode. In the power saving mode, the image forming apparatus 101 can reduce the power consumption of the image forming apparatus 101 by stopping one or more functions of the operation unit 120, an engine unit, and a storage unit to be described later.

However, even when the image forming apparatus 101 is shifted to the power saving mode, the wireless communication device 102 of the image forming apparatus 101 is configured to continue to transmit an advertisement packet of the BLE communication within a given communication range (e.g., within five meters) from the wireless communication device 102.

The BLE communication supports a communication method known as “Advertising,” in which a peripheral apparatus (e.g., image forming apparatus 101) can transmit the advertisement packet at a pre-set time interval, and notify information of the peripheral apparatus to a surrounding device. When the surrounding device (e.g., wireless terminal 104) receives the advertisement packet transmitted from the peripheral apparatus, the surrounding device can acquire the information of the peripheral apparatus.

When the wireless terminal 104 held or carried by the user 105 receives the advertisement packet transmitted from the image forming apparatus 101, the wireless terminal 104 transmits a connection request for requesting a connection using the BLE communication to the image forming apparatus 101.

When the wireless communication device 102 of the image forming apparatus 101 detects the wireless terminal 104 by receiving the connection request transmitted from the wireless terminal 104, the operation unit 120 returns from the power saving mode to a ready mode or a normal mode, and performs wireless authentication of the user 105 carrying the wireless terminal 104. The wireless authentication of the user 105 is performed to determine whether wireless communication between the wireless terminal 104 held or carried by the user 105 and the image forming apparatus 101 is allowed or authenticated.

When the wireless authentication of the user 105 is allowed or authenticated, the operation unit 120 performs fingerprint authentication of the user 105 using the fingerprint feature information of the user 105, whose wireless authentication is allowed or authenticated, based on the feature information of fingerprint registered in advance.

In this configuration, the user 105 can perform the two-factor authentication processing including the wireless authentication, which is an example of the physical property authentication, and the fingerprint authentication, which is an example of the biometric authentication, seamlessly when the user 105 performs the fingerprint authentication operation alone in appearance.

In this configuration, since the operation unit 120 activates a return process from the power saving mode when the wireless communication device 102 detects the wireless terminal 104 using the BLE communication, and the operation unit 120 operates using the power-saving OS as described above, the operation unit 120 can be quickly returned from the power saving mode, and thereby the authentication process can be executed quickly.

Further, since the operation unit 120 performs the wireless authentication using the BLE communication, and performs the fingerprint authentication processing using the fingerprint feature information of the user 105 who is allowed for the wireless authentication, the time required for the fingerprint authentication processing can be reduced.

As described above, in the information processing system 100 that authenticates the user 105 using the two-factor authentication processing, complexity of authentication processing and the waiting time required for the authentication processing can be reduced, and thereby usability or operability of users can be enhanced.

The system configuration illustrated in FIG. 1 is just one example. Alternatively, the information processing system 100 may be a system including a personal computer (PC), a tablet terminal, a smartphone, a game machine, a television conference device, an automatic teller machine (ATM), or other information processing apparatus that authenticates a user.

### Hardware Configuration:

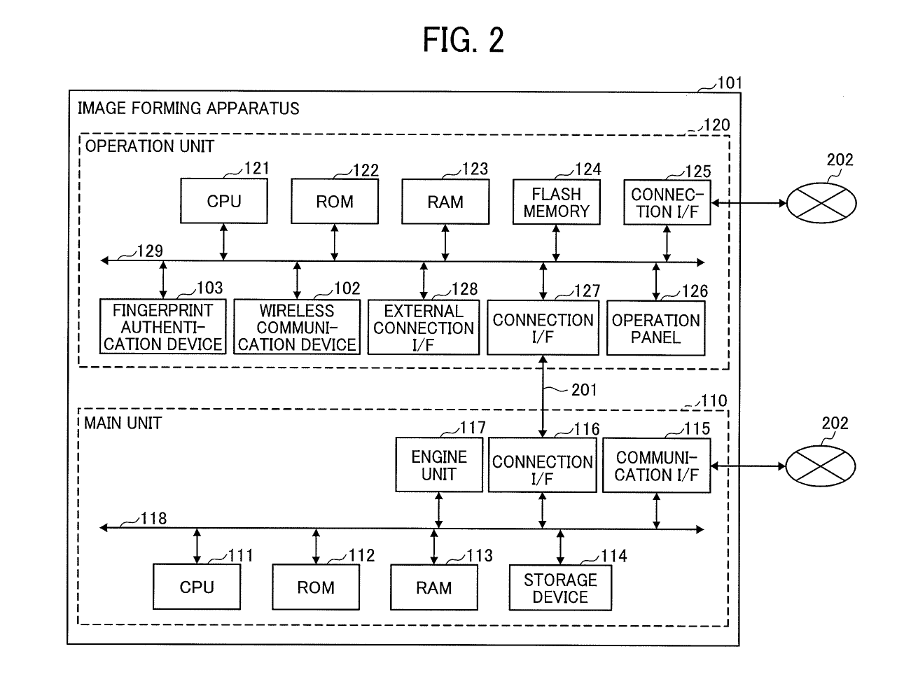

FIG. 2 illustrates an example of a hardware block diagram of the image forming apparatus 101. The image forming apparatus 101 includes, for example, a main unit 110 used for implementing various image forming functions such as a copy function, a scanner function, a facsimile function, and a printer function, and the operation unit 120 used for receiving an operation of the user 105. The main unit 110 and the operation unit 120 are connected to each other through a dedicated communication path 201 or communication channel 201. The communication path 201 can use, for example, a universal serial bus (USB) standard, but can use any standard whether wired or wireless.

The main unit 110 is configured to perform an operation in accordance with an operation received through the operation unit 120. Further, the main unit 110 can be configured to communicate with an external device such as a client personal computer (PC) via a network 202 to perform an operation in accordance with an instruction received from the external device.

### Hardware Configuration of Main Unit:

Hereinafter, a description is given of an example of a hardware configuration of the main unit 110 with reference to FIG. 2. As illustrated in FIG. 2, the main unit 110 includes, for example, a central processing unit (CPU) 111, a read only memory (ROM) 112, a random access memory (RAM) 113, a storage device 114, a communication interface (I/F) 115, a connection interface (FF) 116, an engine unit 117, and a system bus 118.

The CPU 111, for example, circuitry, controls operations of the main unit 110 entirely by executing one or more programs stored in the ROM 112 or storage device 114 using the RAM 113 as a working area. For example, the CPU 111 uses the engine unit 117 to implement various functions such as a copy function, a scanner function, a facsimile function, and a printer function.

The ROM 112 is a nonvolatile memory that stores a basic input/output system (BIOS), to be executed when the main unit 110 is activated, and various settings. The RAM 113 is a volatile memory used as a working area of the CPU 111. The storage device 114 is a non-volatile storage device, such as a hard disk drive (HDD) or a solid state drive (SSD), which stores, for example, an OS, one or more application programs, and various data.

The communication I/F 115 is a network interface, such as a wireless local area network (LAN) interface and/or a wired LAN interface, used for connecting the main unit 110 to the network 202 and communicating with an external device connected to the network 202. The connection I/F 116 is an interface used for communicating between the main unit 110 and the operation unit 120 via the communication path 201.

The engine unit 117 is one or more hardware resources that perform processing other than general-purpose information processing and communication processing, such as a copy function, a scanner function, a facsimile function, and a printer function. The engine unit 117 includes, for example, a scanner (image scanning unit) that scans document image, a plotter (image forming unit) that prints images on sheets such as paper, and a facsimile unit that performs facsimile communication. Further, the engine unit 117 may include optional units, such as a finisher that finishes and sorts printed sheets, and an automatic document feeder (ADF) that automatically feeds documents.

The system bus 118 is connected to the above described each component to transmit address signals, data signals, and various control signals.

### Hardware Configuration of Operation Unit:

Hereinafter, a description is given of an example of a hardware configuration of the operation unit 120 with reference to FIG. 2. As illustrated in FIG. 2, the operation unit 120 includes, for example, a CPU 121, a ROM 122, a RAM 123, a flash memory 124, a communication I/F 125, an operation panel 126, a connection UF 127, an external connection UF 128, a wireless communication device 102, a fingerprint authentication device 103, and a system bus 129.

The CPU 121, for example, circuitry, controls operations of the operation unit 120 entirely by executing one or more programs stored in the ROM 122 or the flash memory 124 using the RAM 123 as a working area. The ROM 122 is a nonvolatile memory that stores a basic input/output system (BIOS), to be executed when the operation unit 120 is activated, and various settings. The RAM 123 is a volatile memory used as a working area of the CPU 121. The flash memory 124 is a non-volatile storage device that stores, for example, an OS, one or more application programs, and various data.

The communication UF 125 is a network interface, such as a wireless LAN interface and/or a wired LAN interface used for connecting the operation unit 120 to the network 202, and communicating with an external device connected to the network 202.

The operation panel 126 receives various inputs in accordance with user operations, and displays various information. The operation panel 126 employs for example, a liquid crystal display (LCD) equipped with a touch panel function, but not limited thereto. The operation panel 126 may employ, for example, an organic electro-luminescence (OEL) display equipped with a touch panel function. Further, in addition or alternative to the display, the operation panel 126 may include an operation device (e.g., hardware keys) and another display device (e.g., lamp that emits light to indicate situation).

The connection I/F 127 is an interface used for communicating between the operation unit 120 and the main unit 110 via the communication path 201.

The external connection I/F 128 is an interface, such as USB interface, used for connecting with an external device.

As described above with reference to FIG. 1, the wireless communication device 102 is the wireless module, the wireless device, the wireless circuit, or the semiconductor device that communicates with the wireless terminal 104 held or carried by the user 105 using the wireless communication, such as the BLE communication.

Further, the wireless communication device 102 can be configured to perform wireless communication other than BLE communication, such as a wireless LAN communication, or can be configured to use a plurality of wireless communications such as a combination of BLE communication and wireless LAN communication.

As described above with reference to FIG. 1, the fingerprint authentication device 103 is the fingerprint authentication device, the fingerprint authentication unit, the fingerprint scanning unit, and the fingerprint reading unit that acquires fingerprint information of the user 105 when the user 105 contacts a sensor of the fingerprint authentication device 103 or when the user 105 approaches proximity of the sensor of the fingerprint authentication device 103.

The fingerprint authentication device 103 is an example of biometric authentication devices for acquiring biometric information used for the biometric authentication of the user 105. Further, the image forming apparatus 101 may be configured to include a vein authentication device for acquiring vein information of the user 105 as the biometric information of the user 105 instead of the fingerprint authentication device 103 or in addition to the fingerprint authentication device 103. Further, the biometric authentication devices can be other biometric authentication devices, such as biometric authentication devices using recognition of face, hand, finger, eye (iris and retina) or voice, but not limited thereto.

The system bus 129 is connected to the above described each component to transmit address signals, data signals, and various control signals.

### Functional Configuration:

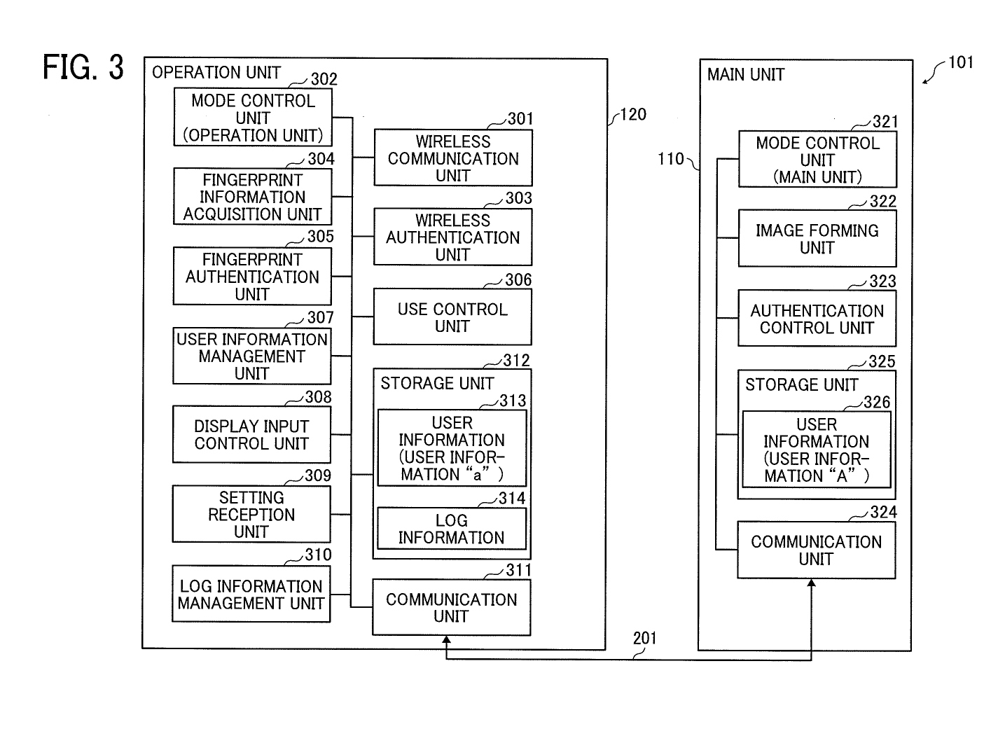

FIG. 3 illustrates an example of a functional block diagram of the image forming apparatus 101 of a first embodiment.

### Functional Configuration of Main Unit:

As illustrated in FIG. 3, the main unit 110 of the image forming apparatus 101 includes, for example, a mode control unit 321 for the main unit 110, an image forming unit 322, an authentication control unit 323, a communication unit 324, and a storage unit 325.

The mode control unit 321 is implemented by, for example, executing one or more programs using the CPU 111 of FIG. 2. The mode control unit 321 is implemented as a first mode control unit that shifts the operation unit 120 and the fingerprint authentication device 103 from a normal mode capable of performing one or more processing to a power saving mode that consumes less power than the normal mode in accordance with a transition or shift condition, which can be pre-set in the main unit 110.

For example, when the image forming apparatus 101 is not being used for a given time period or more, the mode control unit 321 shifts the mode of the operation unit 120, the fingerprint authentication device 103, and the main unit 110 to the power saving mode consuming less power than the normal mode that the image forming processing can be performed.

In addition, when the mode control unit 321 receives a return request from the power saving mode through the communication unit 324 during the power saving mode, the mode control unit 321 returns the main unit 110 from the power saving mode to the normal mode.

The image forming unit 322 is implemented, for example, by executing one or more programs using the CPU 111 of FIG. 2, and the image forming function (e.g., printing, copying, scanning, facsimile) of the image forming apparatus 101 is executed by using the engine unit 117 of FIG. 2.

The authentication control unit 323 is implemented, for example, by executing one or more programs using the CPU 111 of FIG. 2, and allows the user 105, who has been allowed to use the image forming apparatus 101 by the operation unit 120, to use the functions (e.g., printing, copying) of the main unit 110.

The communication unit 324 is implemented by, for example, by executing one or more programs using the CPU 111 of FIG. 2 and the connection I/F 116, and the communication unit 324 communicates with the operation unit 120 via the communication path 201.

The storage unit 325 is implemented by, for example, one or more programs to be executed using the CPU 111, the RAM 113 and storage device 114 in FIG. 2. The storage unit 325 stores information, such as user information 326 (user information “A”), which is a user information registered in advance.

### Functional Configuration of Operation Unit:

Hereinafter, a description is given of a functional block diagram of the operation unit 120 with reference to FIG. 3.

As illustrated in FIG. 3, the operation unit 120 includes, for example, a wireless communication unit 301, a mode control unit 302 for the operation unit 120, a wireless authentication unit 303, a fingerprint information acquisition unit 304, a fingerprint authentication unit 305, a use control unit 306, a user information management unit 307, a display input control unit 308, a communication unit 311, and a storage unit 312.

The operation unit 120 further includes, for example, a setting reception unit 309, and a log information management unit 310.

The wireless communication unit 301 is implemented by, for example, the wireless communication device 102, and performs wireless communication using, for example, the BLE communication, with the wireless terminal 104 held or carried by the user 105.

The wireless communication unit 301 is configured to continue to transmit the advertisement packet, and receive the connection request transmitted from the wireless terminal 104 even after the operation unit 120 shifts to the power saving mode. Further, when the wireless communication unit 301 receives the connection request for requesting a connection of BLE communication from the wireless terminal 104 during the power saving mode, the wireless communication unit 301 notifies a reception notification indicating that the connection request has been received from the wireless terminal 104 to the mode control unit 302.

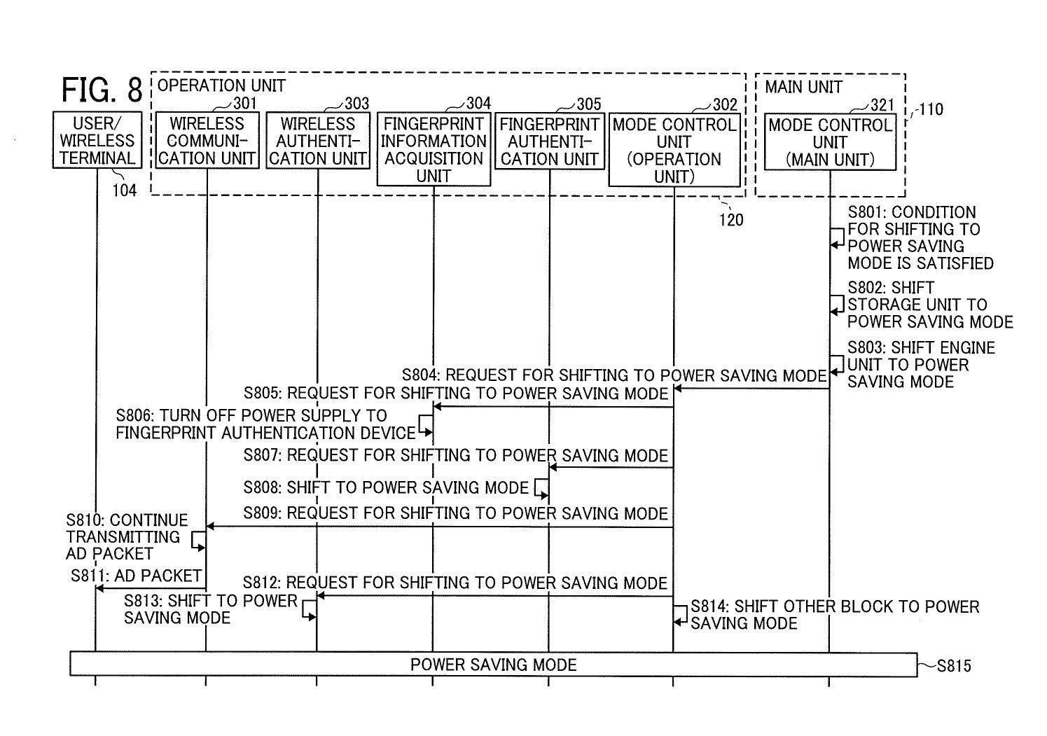

The mode control unit 302 is implemented by, for example, executing one or more programs using the CPU 121 (FIG. 2). The mode control unit 302 is an example of a second mode control unit that activates the operation unit 120 and the fingerprint authentication device 103 when the wireless terminal 104 is detected by the wireless communication unit 301 using the wireless communication during the power saving mode. To be described later with reference to FIG. 8, the mode control unit 302 also controls the sequence of shifting the mode of the operation unit 120 to the power saving mode.

For example, even after the operation unit 120 has shifted to the power saving mode, the mode control unit 302 is being capable of receiving a notification of the connection request from the wireless communication unit 301. When the mode control unit 302 receives the notification of receiving the connection request from the wireless communication unit 301, the mode control unit 302 activates the operation unit 120 and the fingerprint authentication device 103.

The wireless authentication unit 303 is implemented, for example, by executing one or more programs using the CPU 121 (FIG. 2). The wireless communication unit 301 authenticates the user 105 holding or carrying the wireless terminal 104 using authentication information (e.g., wireless device identification (ID)) received from the wireless terminal 104.

For example, when a wireless device identification (ID) received by the wireless communication unit 301 from the wireless terminal 104 is stored in user information 313 (user information “a”), which is information of users registered in advance, the wireless authentication unit 303 allows authentication of the user 105 holding or carrying the wireless terminal 104. On the other hand, when the wireless device ID received by the wireless communication unit 301 from the wireless terminal 104 is not stored in the user information 313 (user information “a”), the wireless authentication unit 303 denies or rejects the authentication of the user 105 holding or carrying the wireless terminal 104.

The fingerprint information acquisition unit 304 is implemented, for example, by the fingerprint authentication device 103, and acquires fingerprint information, which is an example of the biometric information, used for a fingerprint authentication of the user 105, which is an example of the biometric authentication, and notifies the acquired fingerprint information to the fingerprint authentication unit 305.

In this description, the fingerprint information is data (e.g., numerical data, image data) acquired by reading or scanning a fingerprint pattern of the user 105 who has touched or approached proximity of the fingerprint authentication device 103. The method of reading or scanning the fingerprint pattern by the fingerprint authentication device 103 can employ known methods, such as an electrostatic capacitance method that detects an amount of electric charge, a heat-sensitive method that detects heat, and an optical method that analyzes a pattern of a captured fingerprint. In the embodiment, the method of reading or scanning the fingerprint pattern can use any method.

The fingerprint authentication unit 305, which is an example of the biometric authentication unit, is implemented, for example, by executing one or more programs using the CPU 121 (FIG. 2), and authenticates the user 105 who has touched or approached proximity of the fingerprint authentication device 103 using the fingerprint information notified from the fingerprint information acquisition unit 304.

For example, the fingerprint authentication unit 305 extracts fingerprint feature information from the fingerprint information notified from the fingerprint information acquisition unit 304, and calculates a similarity level of the extracted fingerprint feature information and fingerprint information of the registered user stored in the user information 313 (user information “a”). If the calculated similarity level is equal to or greater than a threshold value, the fingerprint authentication unit 305 allows authentication of the user 105. On the other hand, if the calculated similarity level is less than the threshold value, the fingerprint authentication unit 305 denies or rejects the authentication of the user 105.

The fingerprint authentication method described above is just one example, and the fingerprint authentication method can use any known method for the embodiment.

When the wireless authentication of the user 105 is authenticated by the wireless authentication unit 303, the fingerprint authentication unit 305 performs the fingerprint authentication using the fingerprint feature information of the user 105, authenticated by the wireless authentication processing, by referring to the fingerprint information stored in the user information 313 (user information “a”).

The use control unit 306 is implemented, for example, by executing one or more programs using the CPU 121 (FIG. 2), and allows the user 105, who is authenticated by the wireless authentication processing using the wireless authentication unit 303 and by the fingerprint authentication processing using the fingerprint authentication unit 305, to use the image forming apparatus 101.

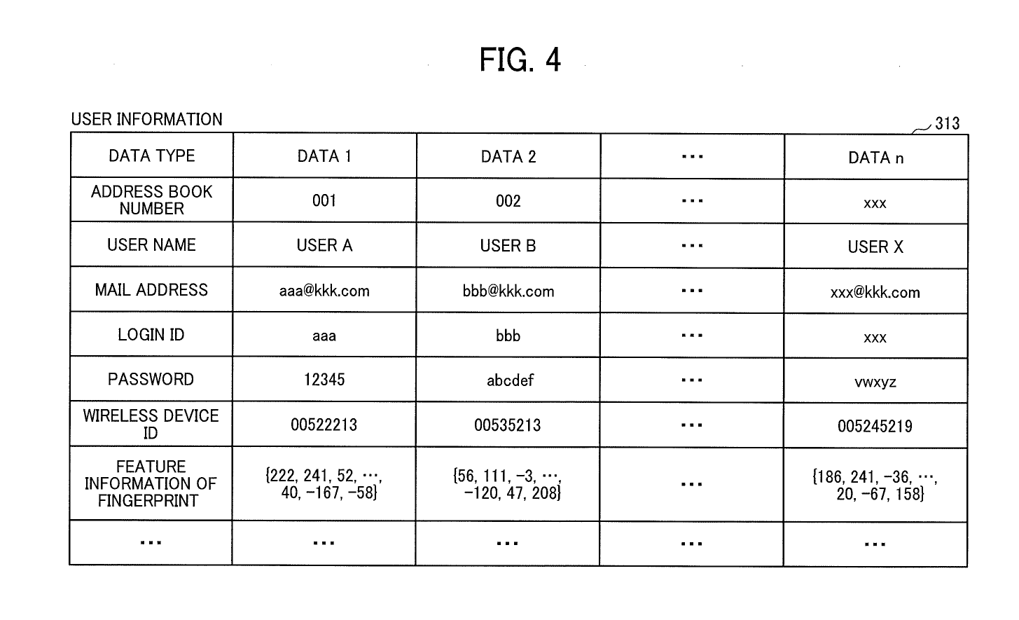

The user information management unit 307 is implemented, for example, by executing one or more programs using the CPU 121 (FIG. 2), and stores, for example, the user information 313 (user information “a”) illustrated in FIG. 4, in the storage unit 312.

FIG. 4 illustrates an example of user information used in the embodiment. The user information 313 (user information “a”) stores information of one or more users registered in advance, and the image forming apparatus 101 allows the user registered in the user information 313 to use the image forming apparatus 101. The user information 326 (user information “A”) stored in the main unit 110 and the user information 313 (user information “a”) stored in the operation unit 120 may be the same or different information. For the simplicity of the description, it is assumed that the same user information is stored as the user information 326 (user information “A”) and the user information 313 (user information “a”).

The user information 313 (user information “a”) stores information of a plurality of users registered in advance. In an example case of FIG. 4, the user information 313 includes information such as “address book number,” “user name,” “mail address,” “login ID,” “password,” “wireless device ID,” and “feature information of fingerprint.”

The “address book number” is an identification number identifying each one of data such as data 1, data 2 . . . , data “n.” The “user name” is, for example, information such as a name of each user. The “mail address” is an e-mail address of each user.

The “login ID” is identification information uniquely set for each user, which is input by each user when each user logs in the image forming apparatus 101. The “login password” is a password, which is input by each user when each user logs in the image forming apparatus 101.

The “wireless device ID” is identification information identifying the wireless terminal 104 held or carried by each user, and is an example of authentication information used in the wireless authentication processing.

The “feature information of fingerprint” is feature information of fingerprint of each user used in the fingerprint authentication, and is an example of the biometric feature information used in the biometric authentication processing. Further, the biometric feature information may indicate any information of a body of each user (e.g., fingerprint pattern).

Referring to FIG. 3 again, the functional configuration of the operation unit 120 is further described.

The display input control unit 308 is implemented, for example, by executing one or more programs using the CPU 121 (FIG. 2). The display input control unit 308 controls displaying of a display screen on the operation panel 126 and receiving an input operation to the operation panel 126.

The setting reception unit 309 is implemented, for example, by executing one or more programs using the CPU 121 (FIG. 2). The setting reception unit 309 instructs the display input control unit 308 to display a setting screen used for setting conditions of the image forming apparatus 101 on the operation panel 126, and changes settings of the image forming apparatus 101 in accordance with the received setting operation.

The log information management unit 310 is implemented, for example, by executing one or more programs using the CPU 121 (FIG. 2). The log information management unit 310 stores, for example, a result of wireless authentication of the user 105, a result of the fingerprint authentication of the user 105, and a use status related to the information processing system 100 (e.g., use status of the image forming apparatus 101) as log information 314 in the storage unit 312 by associating these pieces of information.

The communication unit 311 is implemented, for example, by executing one or more programs using the CPU 121 (FIG. 2) and the connection I/F 127. The communication unit 311 communicates with the main unit 110.

The storage unit 312 is implemented by, for example, by executing one or more programs the CPU 121 (FIG. 2), the flash memory 124 and the RAM 123. The storage unit 312 stores various information such as the user information 313 (user information “a”), and the log information 314.

The functional configuration of the image forming apparatus 101 illustrated in FIG. 3 is just one example. For example, at least a part of the functional configuration included in the operation unit 120 may be included in the main unit 110. Further, at least a part of the functional configuration included in the main unit 110 may be included in the operation unit 120. Further, at least a part of the functional configuration illustrated in FIG. 3 may be implemented by one or more hardware resources.

### Flow of Authentication Processing:

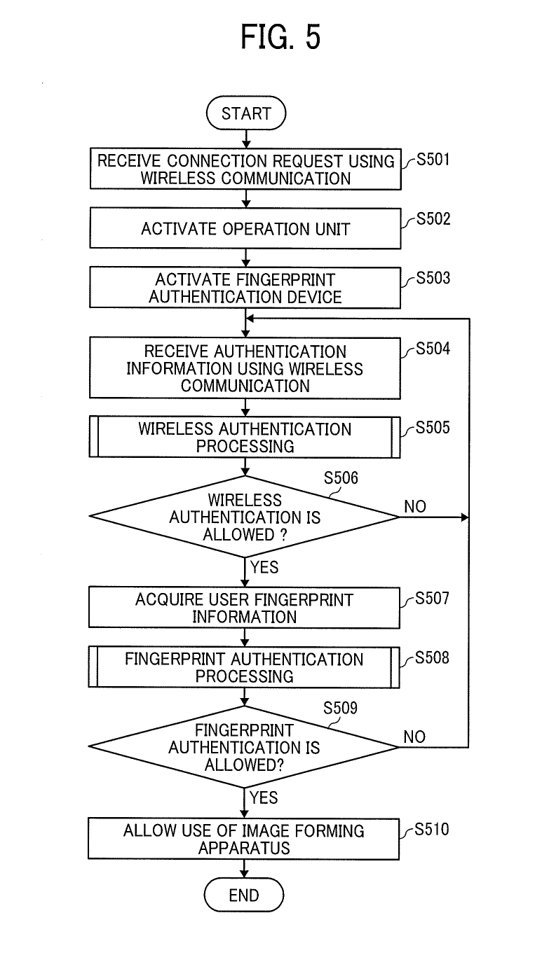

Hereinafter, a description is given of a flow of the authentication processing in the information processing system 100 with reference to FIG. 5.

### First Embodiment

### Flow of Authentication Processing:

FIG. 5 is an example of a flowchart illustrating the steps of authentication processing of the first embodiment. This sequence illustrates an example of the authentication processing when the image forming apparatus 101 authenticates the user 105 during the power saving mode.

At a start of the sequence illustrated in FIG. 5, it is assumed that the operation unit 120, the fingerprint authentication device 103, and the main unit 110 are being in the power saving mode. Further, it is assumed that the wireless communication unit 301 is configured to constantly transmit an advertisement (AD) packet, and is capable to receive a connection request for the wireless communication transmitted from the wireless terminal 104.

In step S501, the wireless communication unit 301 of the image forming apparatus 101 receives the connection request for wireless communication transmitted from the wireless terminal 104. After receiving the connection request, the wireless communication unit 301 notifies, for example, a reception of the connection request for wireless communication to the mode control unit 302.

In step S502, when the mode control unit 302 detects a notification that the wireless communication unit 301 has received the connection request for wireless communication as, for example, a reception interruption, the mode control unit 302 activates the operation unit 120 to return the operation unit 120 from the power saving mode.

In step S503, the mode control unit 302 activates the fingerprint authentication device 103. For example, the mode control unit 302 turns ON the power supply to the fingerprint authentication device 103, and instructs the fingerprint authentication device 103 to start the fingerprint authentication processing.

The processing in step S503 may be executed before the processing in step S502, or the processing in step S503 may be executed in parallel with the processing of step S502.

In step S504, the wireless communication unit 301 receives authentication information (e.g., wireless device ID) from the wireless terminal 104 using wireless communication.

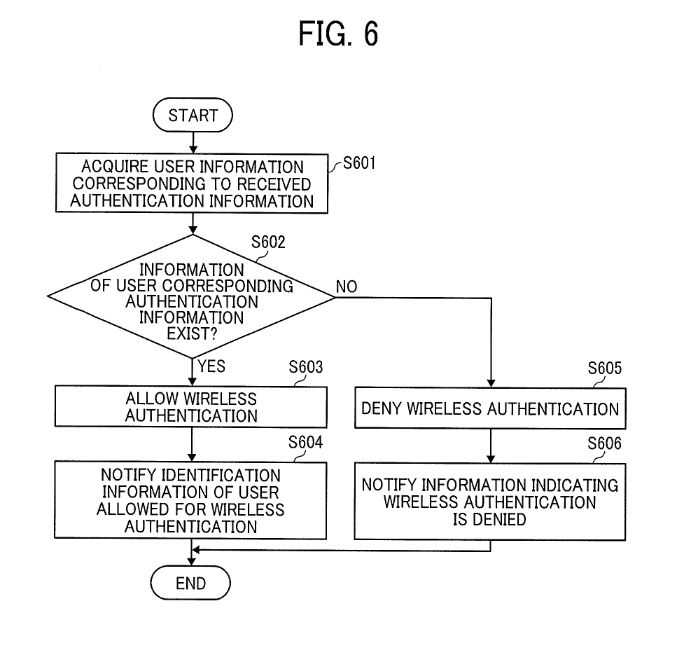

In step S505, the wireless authentication unit 303 executes the wireless authentication processing, such as a sequence illustrated in FIG. 6, using the authentication information (e.g., wireless device ID) received from the wireless terminal 104 in step S504.

FIG. 6 is an example of a flowchart illustrating the steps of the wireless authentication processing of the first embodiment. Phis sequence of FIG. 6 corresponds to the processing in step S505 of FIG. 5.

In step S601, the wireless authentication unit 303 acquires user information, corresponding to the authentication information (e.g., wireless device ID) received from the wireless terminal 104 (step S504 in FIG. 5), from the user information management unit 307. For example, the wireless authentication unit 303 notifies a request for acquiring the user information including the wireless device ID received from the wireless terminal 104 to the user information management unit 307. If the user information corresponding to the wireless device ID included in the request for acquiring the user information exists in the storage unit 312, the user information management unit 307 notifies the user information corresponding to the wireless device ID to the wireless authentication unit 303.

In step S602, the wireless authentication unit 303 determines whether the user information corresponding to the wireless device ID received from the wireless terminal 104 exists (i.e., the wireless authentication unit 303 determines whether the user information is acquired from the user information management unit 307).

If the user information corresponding to the wireless device ID received from the wireless terminal 104 exists (S602: YES), the wireless authentication unit 303 proceeds the sequence to step S603. On the other hand, if the user information corresponding to the wireless device ID received from the wireless terminal 104 does not exist (S602: NO), the wireless authentication unit 303 proceeds the sequence to step S605.

In step S603, the wireless authentication unit 303 allows the wireless authentication for the user 105 holding or carrying the wireless terminal 104, with which the wireless authentication of the user 105 is authenticated correctly.

In step S604, the wireless authentication unit 303 notifies identification information (e.g., address book number of FIG. 4) identifying the user 105 holding or carrying the wireless terminal 104, who is allowed for the wireless authentication, to the fingerprint authentication unit 305 and the use control unit 306.

On the other hand, in step S605, the wireless authentication unit 303 denies or rejects the wireless authentication of the user 105 holding or carrying the wireless terminal 104.

In step S606, the wireless authentication unit 303 notifies information indicating that the wireless authentication of the user 105 is denied to the use control unit 306.

The above described sequence of FIG. 6 is just one example of the wireless authentication processing using the wireless authentication unit 303. The wireless authentication processing using the wireless authentication unit 303 may employ any method as long as the wireless terminal 104 is authenticated or the user 105 holding or carrying the wireless terminal 104 is authenticated using the authentication information acquired from the wireless terminal 104.

Referring to FIG. 5 again, the description of the authentication processing is further continued.

In step S506, the wireless authentication unit 303 proceeds the sequence into different steps depending on whether the wireless authentication is allowed for the user 105.

If the wireless authentication is not allowed for the user 105 (S506: NO), the wireless authentication unit 303 returns the sequence to step S504, and executes the wireless authentication processing again. On the other hand, if the wireless authentication is allowed for the user 105 (S506: YES), the wireless authentication unit 303 proceeds the sequence to step S507.

In step S507, the fingerprint information acquisition unit 304 acquires fingerprint information of the user 105. For example, the fingerprint information acquisition unit 304 reads or scans a pattern of fingerprint of the user 105 that has touched or approached proximity of the fingerprint authentication device 103.

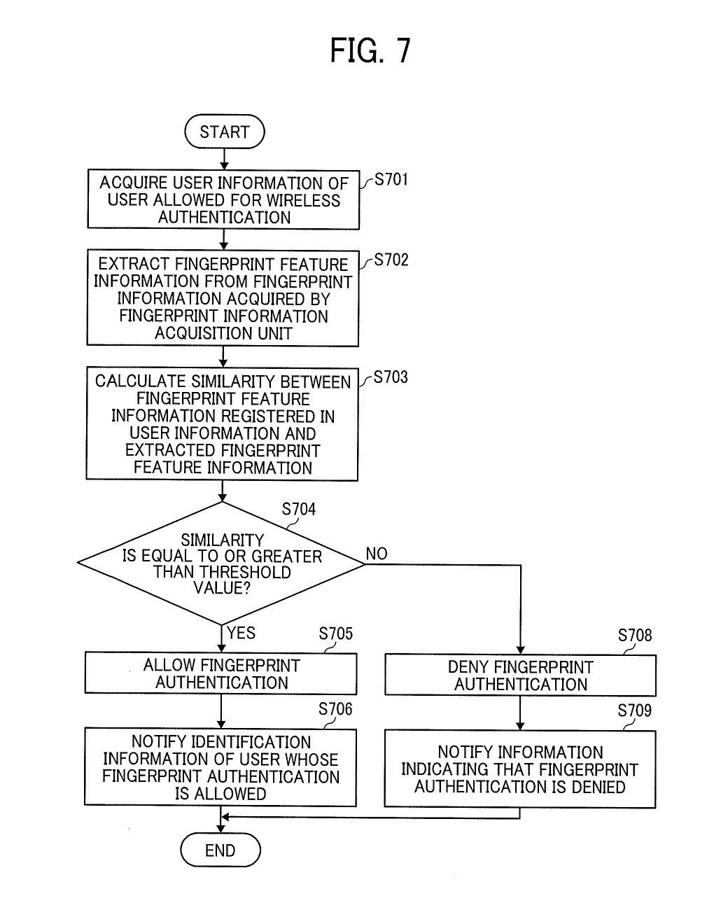

In step S508, the fingerprint authentication unit 305 performs fingerprint authentication processing, which is an example of the biometric authentication processing, such as a sequence illustrated in FIG. 7, using the fingerprint feature information, which is an example of the biometric feature information, registered for the user 105 who is allowed for the wireless authentication in steps S505 and S506.

FIG. 7 is an example of a flowchart illustrating the steps of the fingerprint authentication processing of the first embodiment. Phis sequence of FIG. 7 corresponds to the processing in step S508 of FIG. 5.

In step S701, the fingerprint authentication unit 305 acquires the user information corresponding to the identification information (e.g., address book number) of the user 105, who is allowed for the wireless authentication, from the user information management unit 307. For example, the fingerprint authentication unit 305 transmits a request for acquiring the user information including the address book number notified from the wireless authentication unit 303 to the user information management unit 307, and acquires the user information from the user information management unit 307 in response to the request for acquiring the user information. The user information includes, for example, fingerprint feature information of the user 105 who is allowed for the wireless authentication, which is registered in advance.

In step S702, the fingerprint authentication unit 305 extracts fingerprint feature information, to be used for the fingerprint authentication processing, from the fingerprint information acquired by the fingerprint information acquisition unit 304. The fingerprint feature information to be used for the fingerprint authentication processing includes, for example, information of the center point, branch point(s), and end point(s) of the fingerprint.

In step S703, the fingerprint authentication unit 305 calculates a similarity level between the fingerprint feature information included in the user information acquired in step S701, which is registered in advance for the user 105 who is allowed or authenticated by the wireless authentication processing, and the fingerprint feature information extracted in step S702.

In step S704, the fingerprint authentication unit 305 determines whether the calculated similarity level is equal to or greater than a threshold value.

If the calculated similarity level is equal to or greater than the threshold value (S704: YES), the fingerprint authentication unit 305 proceeds the sequence to step S705. On the other hand, if the calculated similarity level is less than the threshold value (S704: NO), the fingerprint authentication unit 305 proceeds the sequence to step S708.

In step S705, the fingerprint authentication unit 305 allows the fingerprint authentication of the user 105.

In step S706, the fingerprint authentication unit 305 notifies the identification information (e.g., address book number) of the user 105, whose fingerprint authentication is allowed or authenticated, to the use control unit 306.

In step S708, the fingerprint authentication unit 305 denies or rejects the fingerprint authentication of the user 105.

In step S709, the fingerprint authentication unit 305 notifies information indicating that the fingerprint authentication of the user 105 is denied to the use control unit 306.

The above described sequence of FIG. 7 is just one example of the fingerprint authentication processing using the fingerprint authentication unit 305. The fingerprint authentication processing using the fingerprint authentication unit 305 may employ any method as long as the fingerprint information registered for the user, who is allowed for the wireless authentication, is used to authenticate the fingerprint information acquired from the fingerprint information acquisition unit 304.

Referring to FIG. 5 again, the description of the authentication processing is further continued.

In step S509, the use control unit 306 proceeds the sequence into different steps depending on whether the fingerprint authentication is allowed for the user 105.

If the fingerprint authentication of the user 105 is not allowed (S509: NO), the use control unit 306 returns the sequence to step S504, and executes the wireless authentication processing again. On the other hand, if the fingerprint authentication of the user 105 is allowed (S509: YES), the use control unit 306 proceeds the sequence to step S510.

In step S510, the use control unit 306 allows the use of the image forming apparatus 101 by the user 105 who is allowed or authenticated by the wireless authentication processing and the fingerprint authentication processing.

In the above described sequence, the two-factor authentication processing including the wireless authentication processing, which an example of the physical authentication processing, and the fingerprint authentication processing, which an example of the biometric authentication processing, can be performed seamlessly when the user 105 performs an operation of inputting the information of fingerprint using the fingerprint authentication device 103 alone in appearance.

Further, since the operation unit 120 is configured to return from the power saving mode when the wireless communication device 102 detects the wireless terminal 104 using the wireless communication, and the operation unit 120 is operate-able using the power saving OS as described above, the operation unit 120 can quickly return from the power saving mode.

Further, since the operation unit 120 performs the wireless authentication processing using the wireless communication, such as BLE communication, and performs the fingerprint authentication processing using the fingerprint feature information of the user 105 who is allowed for the wireless authentication, the time required for the fingerprint authentication processing can be reduced.

As to the above described image forming apparatus 101, the information processing system 100 can authenticate the user 105 using the two-factor authentication processing, with which the complexity of authentication processing can be reduced, the waiting time of authentication processing can be reduced, and thereby improving or enhancing usability or operability of users.

### Shift to Power Saving Mode:

FIG. 8 is an example of a sequence diagram illustrating a transition or shifting process to the power saving mode in the first embodiment. The sequence of FIG. 8 illustrates an example of a process when the image forming apparatus 101 shifts from the normal mode, in which one or more processing are executable normally, to the power saving mode, in which power consumption is set less than power consumption during the normal mode.

In step S801, in the image forming apparatus 101, for example, when the mode control unit 321 of the main unit 110 detects that a condition of shifting to the power saving mode is satisfied, the mode control unit 321 executes the shifting process to shift the mode of the image forming apparatus 101 to the power saving mode, as indicated by step S802 and the subsequent steps in FIG. 8. The mode transition or mode shifting condition to the power saving mode includes, for example, one case when the wireless terminal 104 is not being detected for a given period of time, and another case when the image forming apparatus 101 is not being used for a given period of time, but not limited thereto.

In steps S802 and S803, the mode control unit 321 shifts the mode of the main unit 110 to the power saving mode.

For example, in step S802, the mode control unit 321 shifts the storage device 114 to the power saving mode. Specifically, for example, when the mode control unit 321 confirms that the writing process of data, being written in the storage device 114, has been completed, the mode control unit 321 turns OFF the power supply to the storage device 114.

In step S803, the mode control unit 321 shifts the mode of the engine unit 117 to the power saving mode. For example, when the mode control unit 321 confirms that the image forming process, being executed by the image forming unit 322, has completed, the mode control unit 321 turns OFF the power supply to the engine unit 117. The processing in step S803 may be executed before the processing in step S802, or the processing in step 803 may be executed in parallel with the processing in step S802.

In step S804, the mode control unit 321 transmits a request for shifting to the power saving mode (hereinafter, power saving shift request) to the operation unit 120. The processing in step S804 may be executed before the processing in steps 5802 and S803, or the processing in step S804 may be executed in parallel with the processing in steps S802 and S803.

When the mode control unit 302 of the operation unit 120 receives the power saving shift request from the main unit 110, the mode control unit 302 is used to control the sequence of steps S805 to S814 to shift the mode of the operation unit 120 to the power saving mode.

For example, in step S805, the mode control unit 302 of the operation unit 120 notifies the power saving shift request for requesting a transition or shifting to the power saving mode to the fingerprint information acquisition unit 304.

In step 806, after the fingerprint information acquisition unit 304 receives the power saving shift request, for example, the fingerprint information acquisition unit 304 turns OFF the power supply to the fingerprint authentication device 103.

In step S807, the mode control unit 302 of the operation unit 120 notifies the power saving shift request for requesting the transition or shifting to the power saving mode to the fingerprint authentication unit 305.

In step S808, after the fingerprint authentication unit 305 receives the power saving shift request, the fingerprint authentication unit 305 shifts the mode to the power saving mode (e.g., stop operation).

In step S809, the mode control unit 302 of the operation unit 120 notifies the power saving shift request for requesting the transition or shifting to the power saving mode to the wireless communication unit 301.

In step S810, after the wireless communication unit 301 receives the power saving shift request, the wireless communication unit 301 instructs the wireless communication device 102 to continue transmitting an advertisement (AD) packet and to receive a connection request for the wireless communication, in which the wireless communication unit 301 maintains a condition of not performing the wireless connection. With this configuration, the wireless communication unit 301 is configured to transmit the AD packet constantly, such as continuously, in step 811.

In step S812, the mode control unit 302 of the operation unit 120 notifies the power saving shift request for requesting the transition or shifting to the power saving mode to the wireless authentication unit 303.

In step S813, after the wireless authentication unit 303 receives the power saving shift request, the wireless authentication unit 303 shifts the mode to the power saving mode (e.g., stop operation).

In step S814, the mode control unit 302 shifts the mode of other one or more blocks including the OS to the power saving mode.

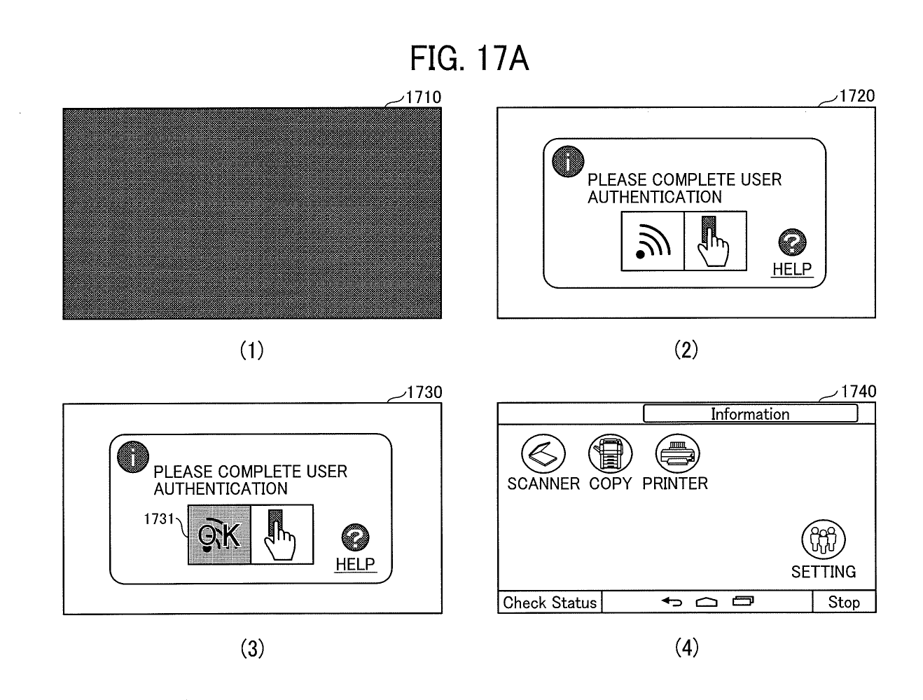

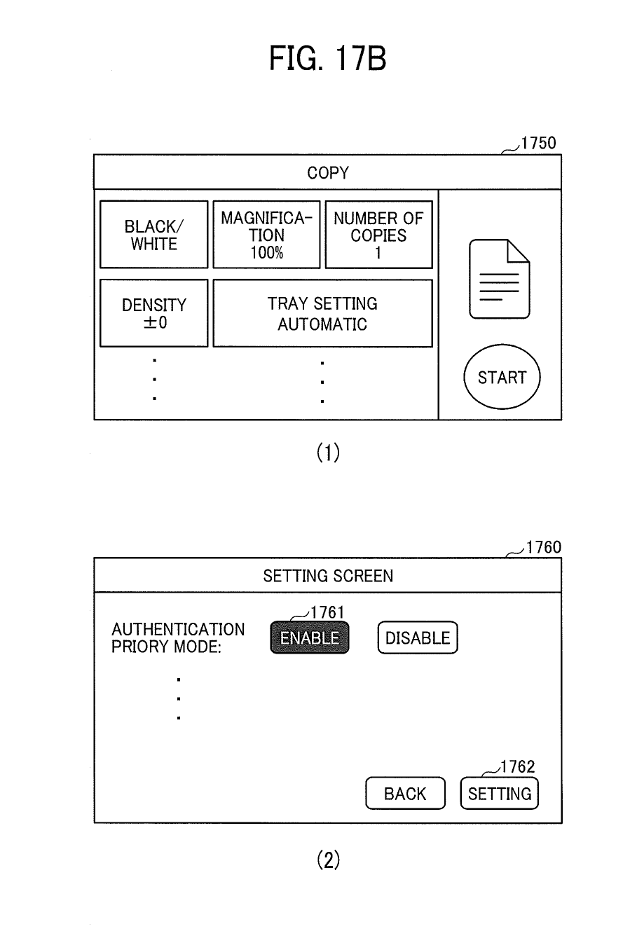

In step S815, the image forming apparatus 101 is set in the power saving mode. Then, for example, the operation panel 126 of the operation unit 120 stops displaying on a display, and turns off a backlight as illustrated in a display screen 1710 of FIG. 17A(1).

Authentication from Power Saving Mode:

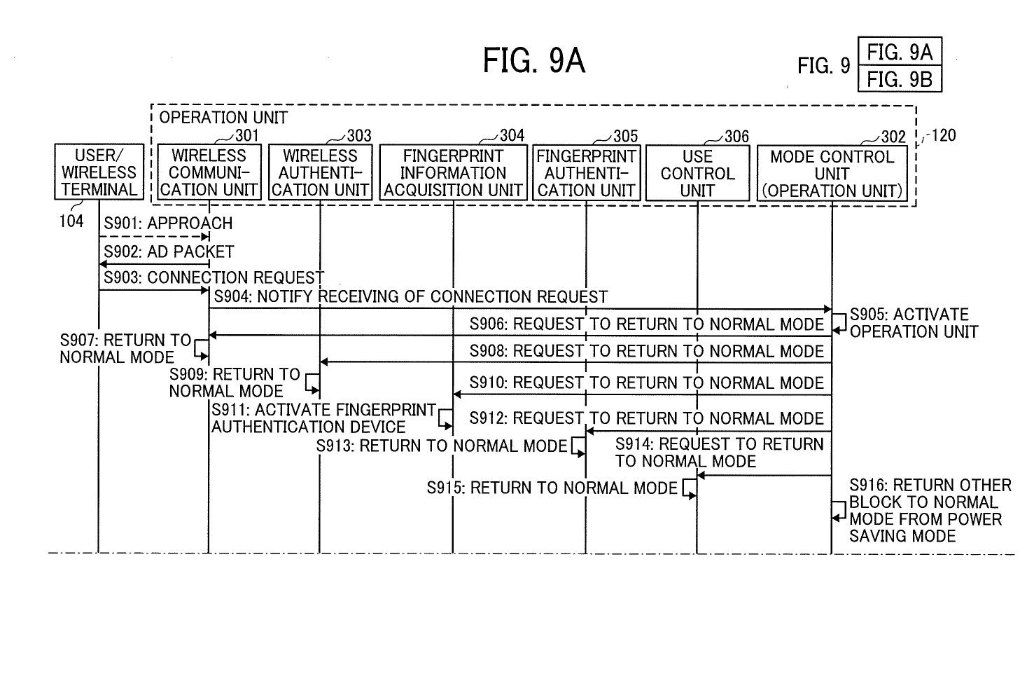

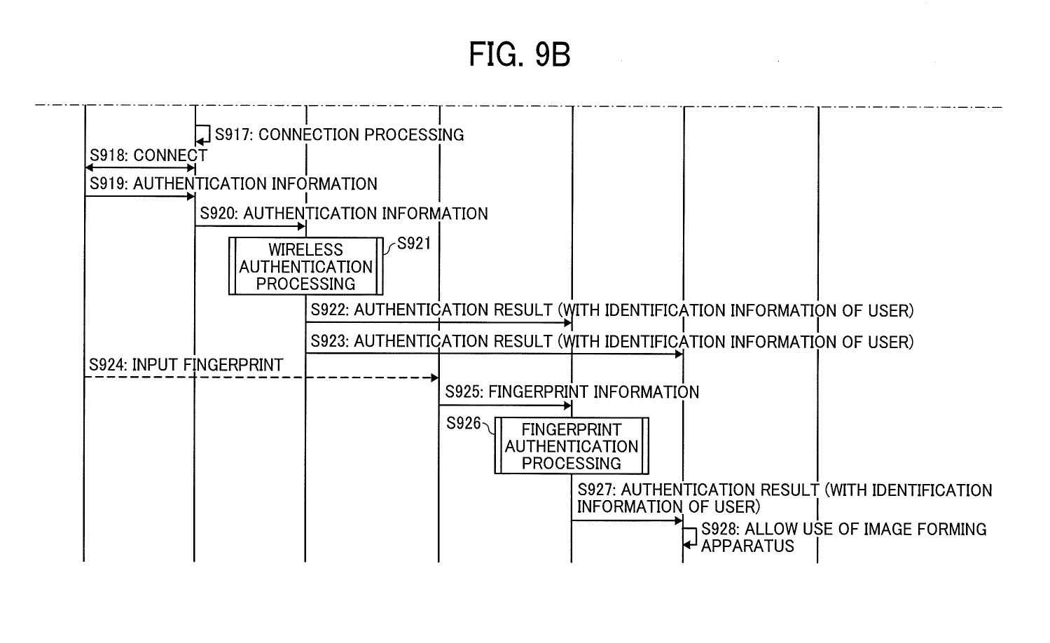

FIG. 9 (9A and 9B) is an example of a sequence diagram illustrating the authentication processing activated during the power saving mode in the first embodiment. The sequence of FIG. 9 illustrates an example of the authentication processing of the user 105 using the image forming apparatus 101 when the image forming apparatus 101 being in the power saving mode (FIG. 8) receives the advertisement (AD) packet being transmitted from the wireless communication unit 301 during the power saving mode. In FIG. 9, a broken-line arrow indicates an action or operation performed by the user 105.

In step S901, it is assumed that the user 105 holding or carrying the wireless terminal 104 approaches the operation unit 120, and enters within a communication range of the BLE communication performed by the wireless communication unit 301 (e.g., within 5-meter range).

In step S902, after the wireless terminal 104 enters within the communication range of BLE communication performed by the wireless communication unit 301, the wireless terminal 104 receives the advertisement (AD) packet being transmitted from the wireless communication unit 301 during the power saving mode.

In step S903, after the wireless terminal 104 receives the AD packet being transmitted from the wireless communication unit 301, the wireless terminal 104 transmits a connection request for requesting a connection using the BLE communication to the wireless communication unit 301, which is used as a transmission source of the AD packet.

In step S904, after the wireless communication unit 301 receives the connection request from the wireless terminal 104, the wireless communication unit 301 notifies a notification of receiving the connection request to the mode control unit 302.

In step S905, the mode control unit 302 is activated based on, for example, the notification of the connection request received from the wireless communication unit 301 (i.e., interruption by reception), and the mode control unit 302 activates the operation unit 120 after receiving the notification of the connection request.

In step S906, the mode control unit 302 notifies a request for returning to the normal mode (hereinafter, normal mode return request) to the wireless communication unit 301, in which the normal mode return request is transmitted to request to return to the normal mode from the power saving mode.

In step S907, after the wireless communication unit 301 receives the normal mode return request, the wireless communication unit 301 returns from the power saving mode to the normal mode, with which the wireless communication unit 301 can be connected to the wireless terminal 104 wirelessly.

In step S908, the mode control unit 302 notifies the normal mode return request to the wireless authentication unit 303.

In step S909, the wireless authentication unit 303 returns from the power saving mode to the normal mode, with which the wireless authentication processing is executable.

In step S910, the mode control unit 302 notifies the normal mode return request to the fingerprint information acquisition unit 304.

In step S911, the fingerprint information acquisition unit 304 activates the fingerprint authentication device 103 to return the fingerprint authentication device 103 to the normal mode from the power saving mode so that the fingerprint information of the user 105 can be acquired using the fingerprint authentication device 103.

In step S912, the mode control unit 302 notifies the normal mode return request to the fingerprint authentication unit 305.

In step S913, the fingerprint authentication unit 305 returns from the power saving mode to the normal mode, with which the fingerprint authentication processing is executable.

In step S914, the mode control unit 302 notifies the normal mode return request to the use control unit 306.

In step S915, the use control unit 306 returns from the power saving mode to the normal mode, with which the user 105 can be authenticated by the wireless authentication processing and the fingerprint authentication processing, and if the user 105 is authenticated correctly as described in the following sequence of steps S916 to S927, the user 105 can use the image forming apparatus 101 as described in step S928.

In step S916, the mode control unit 302 returns the mode of each block to the normal mode from the power saving mode. With this configuration, the display input control unit 308 turns ON the backlight of the operation panel 126, and, for example, causes the display screen 1720 illustrated in FIG. 17A(2) to be displayed on the operation panel 126.

Further, when the wireless communication unit 301 returns from the power saving mode to the normal mode, for example, the wireless communication unit 301 executes a connection processing with the wireless terminal 104 using the BLE communication in step S917. Then, in step S918, the wireless terminal 104 is connected to the wireless communication unit 301 wirelessly.

In step S919, after the wireless terminal 104 is connected to the wireless communication unit 301 using the wireless communication, the wireless terminal 104 transmits authentication information (e.g., wireless device ID of wireless terminal 104) to the wireless communication unit 301.

In step S920, the wireless communication unit 301 notifies the authentication information, received from the wireless terminal 104, to the wireless authentication unit 303.

In step S921, the wireless authentication unit 303 executes the wireless authentication processing, such as the sequence illustrated in FIG. 6. In this example case, the description is continued by assuming that the wireless authentication processing is allowed for the user 105 carrying the wireless terminal 104.

In steps 5922 and 5923, the wireless authentication unit 303 notifies an authentication result indicating that the wireless authentication is allowed for the user 105 carrying the wireless terminal 104 to the fingerprint authentication unit 305 and the use control unit 306. The authentication result includes, for example, the identification information (e.g., address book number) identifying the user 105 who is allowed for the wireless authentication. Then, the display input control unit 308 causes a display screen 1730, illustrated in FIG. 17A(3), to be displayed on the operation panel 126. The display screen 1730 displays a section 1731 indicating that the wireless authentication of the user 105 is allowed, and the fingerprint authentication operation is further required.

In step S924, the user 105 holding or carrying the wireless terminal 104 performs a fingerprint input operation using the fingerprint authentication device 103.

In step S925, the fingerprint information acquisition unit 304 acquires fingerprint information of the user 105, and transmits the acquired fingerprint information to the fingerprint authentication unit 305.

In step S926, the fingerprint authentication unit 305 executes the fingerprint authentication processing, such as the sequence illustrated in FIG. 7. In this example case, the description is continued by assuming that the fingerprint authentication processing is allowed for the user 105 carrying the wireless terminal 104.

In step S927, the fingerprint authentication unit 305 notifies an authentication result indicating that the fingerprint authentication processing is allowed for the user 105 carrying the wireless terminal 104 to the use control unit 306. The authentication result includes, for example, the identification information (e.g., address book number) of the user 105 who is allowed for the fingerprint authentication.

In step S928, the use control unit 306 allows a use of the image forming apparatus 101 by the user 105 who has allowed for the wireless authentication processing and the fingerprint authentication processing. Then, the display input control unit 308 causes a display screen 1740, illustrated in FIG. 17A(4), to be displayed on the operation panel 126. In this situation, the user 105 can use a function (e.g., setting of apparatus) that can be implemented by the operation unit 120 alone.

In this situation, when a function using the main unit 110 (e.g., copy) is selected, the operation unit 120 requests the main unit 110 to return to the normal mode from the power saving mode, and displays a message such as “wait for a while” on the operation panel 126 until the main unit 110 is activated.

Return from Power Saving Mode of Main Unit:

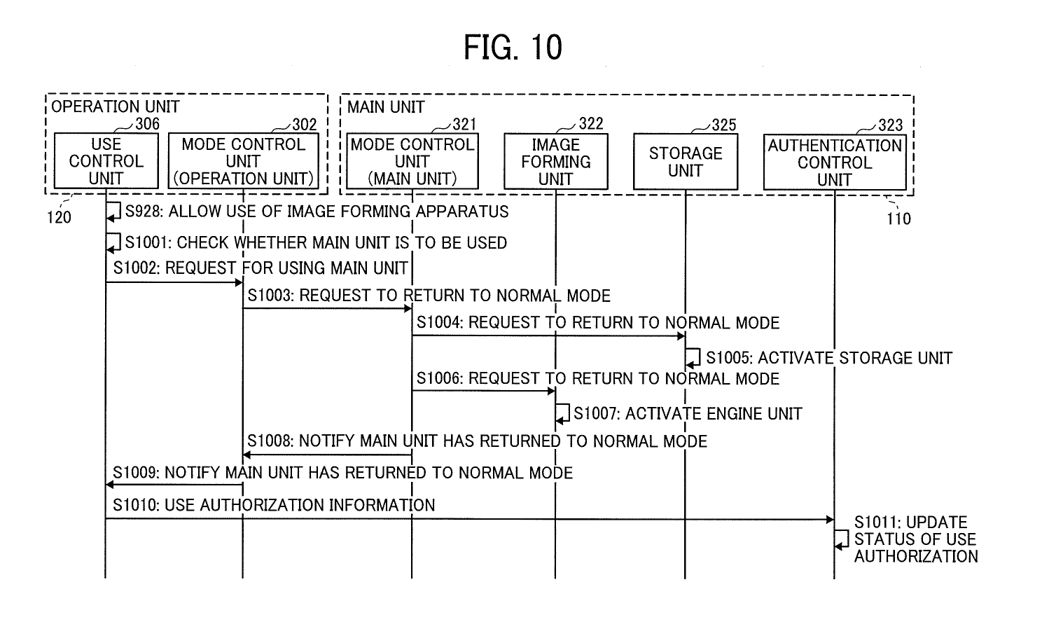

FIG. 10 is an example of a sequence diagram illustrating a process of returning from the power saving mode of the main unit 110 in the first embodiment. This sequence of FIG. 10 illustrates an example of a process after the use control unit 306 allows the use of the image forming apparatus 101 by the user 105 who is allowed or authenticated by the wireless authentication processing and the fingerprint authentication processing by preforming the sequence of FIG. 9.

In step S1001, the use control unit 306 checks whether the main unit 110 is to be used by the user 105, who is allowed to use the image forming apparatus 101. For example, the use control unit 306 determines that the user 105 is to use the main unit 110 when the user 105 is to perform specific operations such as copying, printing, and scanning. Further, the use control unit 306 determines that the user 105 is not to use the main unit 110 when the user 105 inputs or adjusts settings from a setting screen of the image forming apparatus 101. In another example case, the use control unit 306 may determine whether the user 105 can use the main unit 110 depending on user attribute of the user 105 such as the user 105 is an administrator who has an authority to manage the image forming apparatus 101, or the user 105 is a general user who has no authority to manage the image forming apparatus 101.

When the use control unit 306 determines that the user 105 is to use the main unit 110, the sequence of step S1002 and subsequent steps are executed.

In step S1002, the use control unit 306 transmits a request for using the main unit 110 to the mode control unit 302.

In step S1003, in response to the request for using the main unit 110 received from the use control unit 306, the mode control unit 302 transmits the normal mode return request to the main unit 110 to return the main unit 110 to the normal mode from the power saving mode.

In step S1004, in response to the normal mode return request received from the operation unit 120, the mode control unit 321 requests the storage unit 325 to return to the normal mode from the power saving mode.

In step S1005, the storage unit 325 activates the storage device 114.

In step S1006, in response to the normal mode return request received from the operation unit 120, the mode control unit 321 requests the image forming unit 322 to return to the normal mode from the power saving mode.

In step S1007, the image forming unit 322 activates the engine unit 117.

In step S1008, the mode control unit 321 notifies a notification indicating that the main unit 110 has returned to the normal mode from the power saving mode to the operation unit 120.

In step S1009, the mode control unit 302 notifies the notification indicating that the main unit 110 has returned to the normal mode from the power saving mode to the use control unit 306.

In step S1010, the use control unit 306 notifies use authorization information indicating that the use of the image forming apparatus 101 by the user 105 is allowed to the main unit 110.

In step S1011, the authentication control unit 323 of the main unit 110 updates the status of use authorization of the main unit 110. For example, if the use of the main unit 110 by the user 105 is already allowed when the authentication control unit 323 receives the use authorization information from the use control unit 306 (S1010), the authentication control unit 323 maintains the current status allowing the user 105 to use the main unit 110 in step S1011. On the other hand, if the use of the main unit 110 by the user 105 is not yet allowed when the authentication control unit 323 receives the use authorization information from the use control unit 306 (S1010), the authentication control unit 323 newly allows the user 105 to use the main unit 110 in step S1011. Then, the display input control unit 308 causes a display screen 1750, illustrated in FIG. 17B(1), to be displayed on the operation panel 126. In this situation, the user 105 can use one or more functions (e.g., copying, scanning, printing) using the main unit 110.

Then, if the copy function is selected in the display screen 1740 illustrated in FIG. 17A(4), the display screen 1750 is displayed as an operation screen of the copy function set for a copy application as illustrated in FIG. 17B(1).

As to the first embodiment, the information processing system 100 can authenticate the user 105 using the two-factor authentication processing, with which the complexity of authentication processing can be reduced, the waiting time of authentication processing can be reduced, and thereby improving or enhancing usability or operability of users.

### Second Embodiment

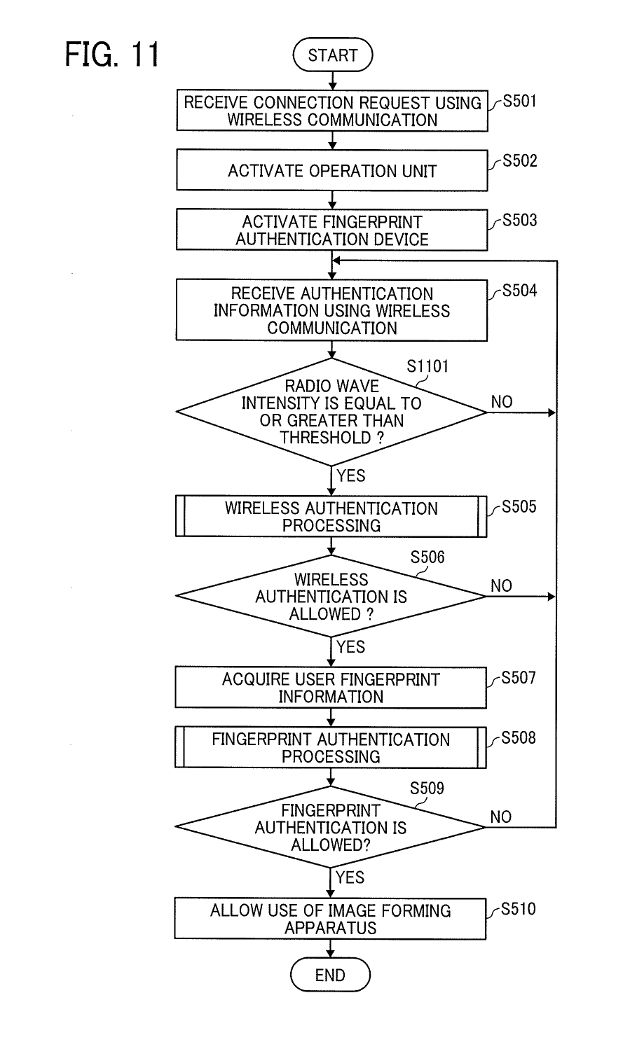

Hereinafter, a description is given of a second embodiment with reference to FIG. 11, in which the wireless communication unit 301 controls the wireless authentication processing using the wireless authentication unit 303 in accordance with intensity of radio wave (hereinafter, radio wave intensity) received from the wireless terminal 104. Flow of Authentication Processing:

FIG. 11 is an example of a flowchart illustrating the steps of authentication processing of the second embodiment. The sequence illustrated in FIG. 11 includes steps S501 to S504 and S505 to 5510, which are same as the authentication processing of the first embodiment illustrated in FIG. 5, and thereby the difference from the first embodiment is to be described with reference to FIG. 11.

In step S1101, the wireless authentication unit 303 determines whether the radio wave intensity of the authentication information received in step S504 is equal to or greater than a threshold value (i.e., first threshold), and executes the wireless authentication processing in step S505 when the radio wave intensity is equal to or greater than the threshold value (S1101: YES). On the other hand, if the radio wave intensity is less than the threshold value (S1101: NO), the wireless authentication unit 303 does not perform the wireless authentication processing, and returns the sequence to step S504.

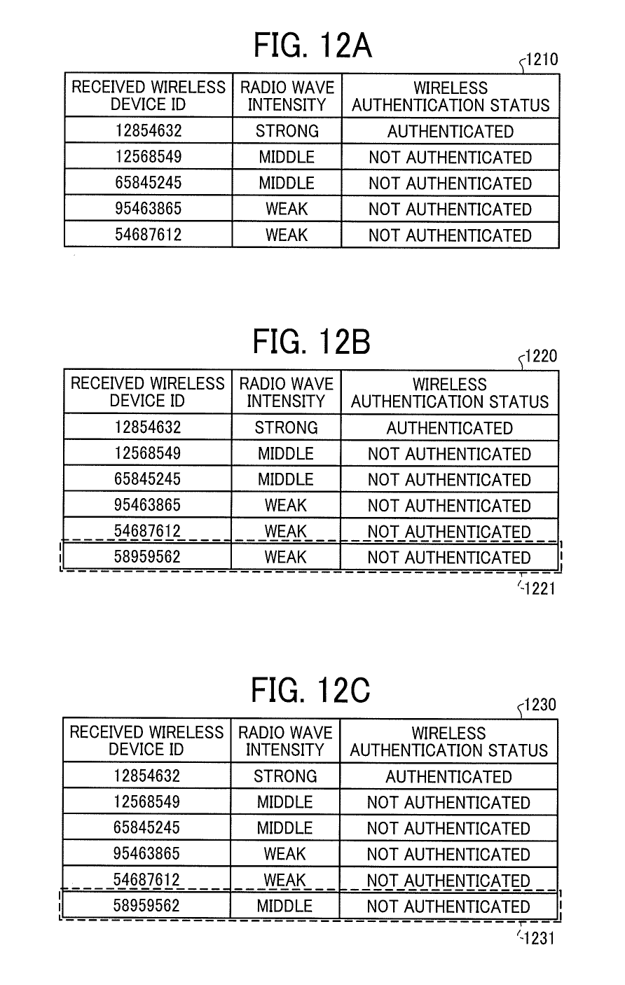

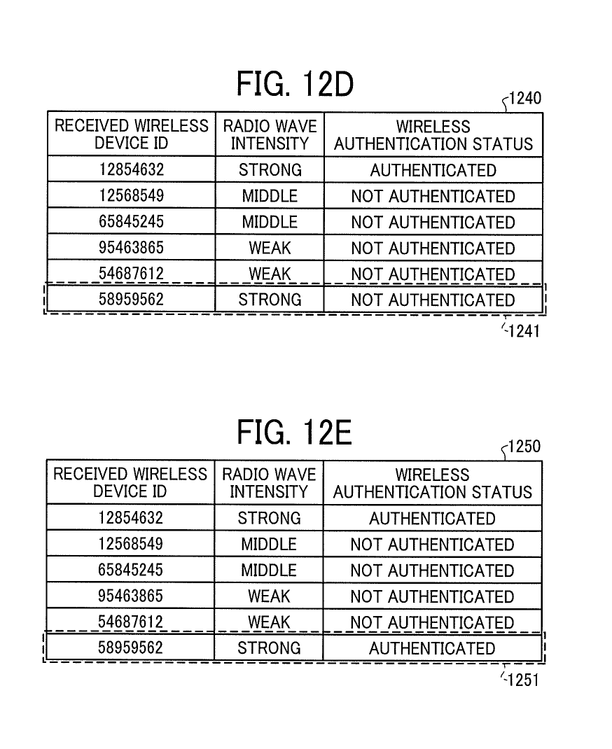

FIG. 12 (12A, 12B, 12C, 12D, and 12E) is an example of tables describing relationships between the radio wave intensity and wireless authentication in the second embodiment.

In this description, it is assumed that when the distance between the wireless communication unit 301 and the wireless terminal 104 is less than one meter (1 m), the received radio wave intensity is “strong,” when the distance between the wireless communication unit 301 and the wireless terminal 104 is from 1 m to less than 2 m, the received radio wave intensity is “middle,” and when the distance between the wireless communication unit 301 and the wireless terminal 104 is two meters (2 m) or more, the received radio wave intensity is “weak.” Further, when the received radio wave intensity is “strong,” it is assumed that the wireless authentication unit 303 determines that the radio wave intensity is equal to or greater than the threshold value (i.e., first threshold) used in step S1101.

Each table illustrated in FIG. 12 illustrates an example of status of “received wireless device ID,” “(received) radio wave intensity,” and “wireless authentication status” of each one of a plurality of the wireless terminals 104 when the wireless communication unit 301 receives the wireless device ID of each one of the plurality of the wireless terminals 104 using the BLE communication.

The “received wireless device ID” indicates the wireless device ID included in the radio wave received by the wireless communication unit 301. The “radio wave intensity” indicates the intensity of radio wave received by the wireless communication unit 301. The “wireless authentication status” is information indicating whether the wireless authentication of each wireless device ID is allowed or authenticated.

The wireless authentication unit 303 stores information, such as “received wireless device ID,” “radio wave intensity,” and “authentication status” illustrated in FIG. 12 in the storage unit 312, and manages these pieces of information.

In an example of Table 1210 illustrated in FIG. 12A, the wireless communication unit 301 receives the radio waves including the wireless devices ID from five wireless terminals 104, in which the radio wave intensity corresponding to the wireless device ID of “12854632” is “strong.” Further, Table 1210 indicates that the radio wave intensity corresponding to the other wireless devices ID are “middle” or “weak.”

In this example case, the wireless authentication unit 303 performs the wireless authentication processing for the wireless terminal 104 corresponding to the wireless device ID of “12854632” having the radio wave intensity of “strong,” and does not perform the wireless authentication processing for the wireless terminals 104 corresponding to other wireless device IDs having the radio wave intensity of “middle” or “weak.”

Further, Table 1210 (FIG. 12A) indicates that that wireless authentication status of the wireless terminal 104 corresponding to the wireless device ID of “12854632” is set with “authenticated” for the wireless communication. Further, Table 1210 (FIG. 12A) indicates that the wireless authentication status of the wireless terminals 104 corresponding to the other wireless device IDs having the radio wave intensity of “middle” or “weak” are set with “not authenticated” indicating that the wireless authentication is not allowed.

In this situation, for example, when the fingerprint information of the user 105 is acquired in step S507 of FIG. 11, the fingerprint authentication unit 305 performs the fingerprint authentication processing using the fingerprint authentication information of the user 105 corresponding to the wireless device ID of “12854632.”

Further, Table 1220 illustrated in FIG. 12B indicates that the wireless device ID of “58959562,” indicated in a dashed line 1221, is newly received by the wireless communication unit 301. In this case, since the radio wave intensity corresponding to the wireless device ID of “58959562” is “weak” (i.e., less than the threshold value), the wireless authentication unit 303 does not perfoiiii the wireless authentication processing for the wireless terminal 104 corresponding to the wireless device ID of “58959562.”

Further, Table 1230 illustrated in FIG. 12C indicates that the wireless terminal 104, corresponding to the wireless device ID of “58959562” indicated in a dashed line 1231, approaches the wireless communication unit 301 within the distance range from 1 m or more to less than 2 m, and the radio wave intensity is changed to “middle” (i.e., change from FIG. 12B to FIG. 12C). In this case, since the radio wave intensity corresponding to the wireless device ID of “58959562” is “middle” (i.e., less than the threshold value), the wireless authentication unit 303 does not perform the wireless authentication processing for the wireless terminal 104 corresponding to the wireless device ID of “58959562.”

Further, Table 1240 illustrated in FIG. 12D indicates that the wireless terminal 104, corresponding to the wireless device ID of “58959562” illustrated in a broken line 1241, approaches the wireless communication unit 301 within the distance range less than 1 m, and the radio wave intensity is changed to “strong” (i.e., change from FIG. 12C to FIG. 12D). In this case, since the radio wave intensity corresponding to the wireless device ID of “58959562” is “strong” (i.e., the threshold value or more), the wireless authentication unit 303 performs the wireless authentication processing for the wireless terminal 104 corresponding to the wireless device ID of “58959562.”

Further, when the wireless authentication unit 303 performs the wireless authentication processing for the wireless terminal 104 corresponding to the wireless device ID of “58959562,” Table 1250 illustrated in FIG. 12E indicates that the wireless authentication of wireless terminal 104, corresponding to wireless device ID of “58959562” illustrated in dashed line 1251, is allowed, and the authentication status for the wireless communication is changed to “authenticated.”

In this situation, for example, when the fingerprint information of the user 105 is acquired in step S507 in FIG. 11, the fingerprint authentication unit 305 performs the fingerprint authentication processing using the fingerprint authentication information for the user 105 corresponding to each of the wireless devices ID of “12854632” and “58959562.”

As above described, when the wireless device ID is received by the wireless communication unit 301, and the intensity of radio wave received from the wireless terminal 104 is equal to or greater than the threshold value (i.e., first threshold), the wireless terminal 104 performs the wireless authentication processing for the user 105 carrying the wireless terminal 104.

### Cancelling of Wireless Authentication:

The image forming apparatus 101 can be configured to cancel the wireless authentication of the wireless terminal 104 when the radio wave intensity received from the wireless terminal 104 is less than a threshold value (i.e., second threshold) for one or more of the wireless device Ills received by the wireless communication unit 301.

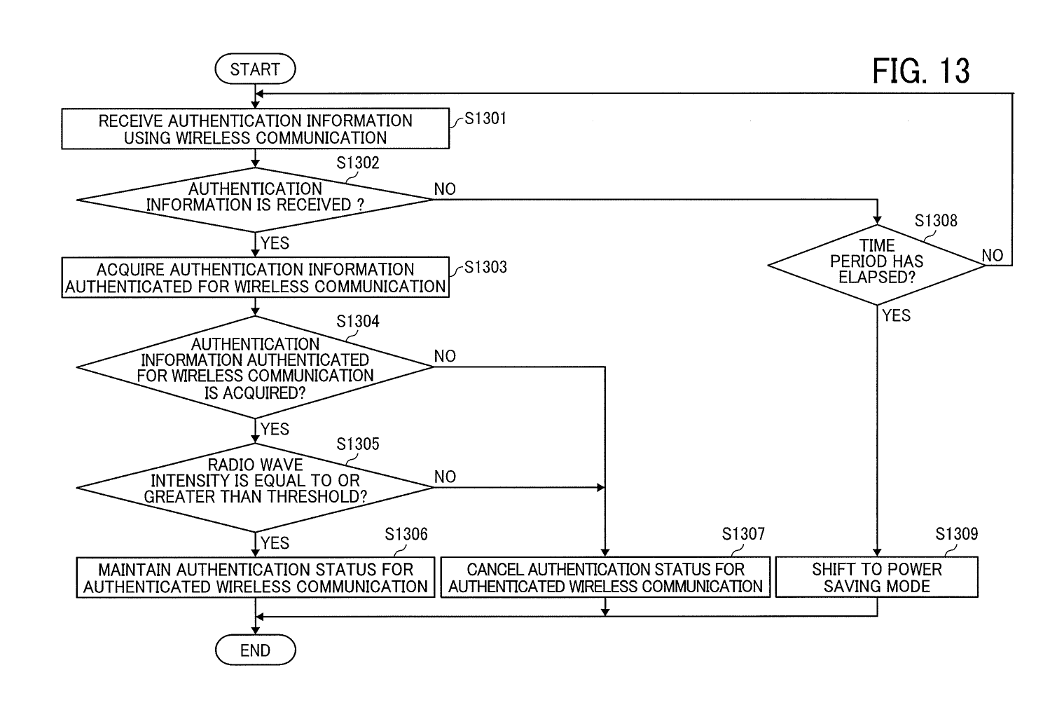

FIG. 13 is an example of a flowchart illustrating the steps of a process of cancelling of the wireless authentication in the second embodiment. This sequence of FIG. 13 is preferably performed in parallel with the authentication processing illustrated in FIG. 11, or after the authentication processing illustrated in FIG. 11.

In step S1301, the wireless communication unit 301 receives the authentication information (e.g., wireless device ID) transmitted from the wireless terminal 104 using the BLE communication.

In step S1302, the wireless authentication unit 303 determines whether the wireless communication unit 301 has received the authentication information.

If the wireless communication unit 301 has received the authentication information (S1302: YES), the wireless authentication unit 303 proceeds the sequence to step S1303. On the other hand, if the wireless communication unit 301 fails to receive the authentication information (S1302: NO), the wireless authentication unit 303 proceeds the sequence to step S1308.

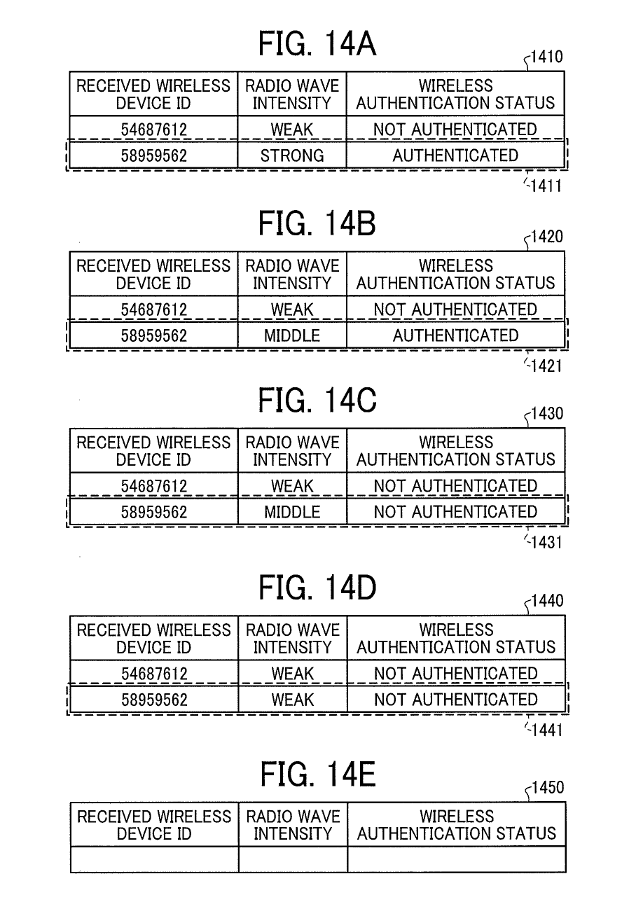

In step S1303, the wireless authentication unit 303 acquires authentication information already authenticated for the wireless communication. With this processing, in an example of Table 1410 illustrated in FIG. 14A, the wireless device ID of “58959562” having the wireless authentication status of “authenticated” is acquired. On the other hand, in an example of Table 1430 illustrated in FIG. 14C, since there is no wireless device ID having the wireless authentication status of “authenticated,” the wireless device ID (authentication information) is not acquired.

In step S1304, the wireless authentication unit 303 determines whether the authentication information already authenticated for the wireless communication is acquired.

If the authentication information already authenticated for the wireless communication is acquired (S1304: YES), the wireless authentication unit 303 proceeds the sequence to step S1305. On the other hand, if the authentication information already authenticated for the wireless communication cannot be acquired (S1304: NO), the wireless authentication unit 303 proceeds the sequence to step S1307.

In step S1305, the wireless authentication unit 303 determines whether the radio wave intensity corresponding to the authentication information (e.g., wireless device ID) already authenticated for the wireless communication is equal to or greater than the threshold value (i.e., second threshold). In this example case, it is assumed that if the received radio wave intensity is “strong,” the wireless authentication unit 303 determines that the radio wave intensity is equal to or greater than the threshold value (i.e., second threshold).

If the radio wave intensity corresponding to the authentication information already authenticated for the wireless communication is equal to or greater than the threshold value (i.e., second threshold) (S1305: YES), the wireless authentication unit 303 proceeds the sequence to step S1306. On the other hand, if the radio wave intensity corresponding to the authentication information already authenticated for the wireless communication is less than the threshold value (i.e., second threshold) (S1305: NO), the wireless authentication unit 303 proceeds the sequence to step S1307.

In step S1306, the wireless authentication unit 303 maintains the wireless authentication status of the wireless device ID, authenticated for the wireless communication, at the “authenticated.”

In step S1307, the wireless authentication unit 303 cancels the wireless authentication status of the wireless device ID, which has been authenticated for the wireless communication, and sets the wireless authentication status of “not authenticated” to prohibit the user 105 from using the image forming apparatus 101, in which the wireless communication between the wireless communication device 102 and the wireless terminal 104 carried by the user 105 is disconnected when the wireless authentication status of “not authenticated” is set.

Further, when the sequence proceeds from step S1302 to step S1308, the wireless authentication unit 303 determines whether a given time period (e.g., 5 minutes) has elapsed after the wireless authentication unit 303 becomes unable to receive the authentication information from the wireless terminal 104.

If the given time period has not yet elapsed (S1308: NO), the wireless authentication unit 303 returns the sequence to step S1301, and causes the wireless communication unit 301 to receive the authentication information again. On the other hand, when the given time period has elapsed (S1308: YES), the wireless authentication unit 303 proceeds the sequence to step S1309.

In step S1309, the wireless authentication unit 303 notifies that the mode transition or mode shifting condition to the power saving mode is satisfied to the mode control unit 321, and then the mode control unit 321 shifts the image forming apparatus 101 to the power saving mode using the sequence illustrated in FIG. 8.

FIG. 14 is another example of tables describing relationships between the radio wave intensity and wireless authentication in the second embodiment.

Table 1410 illustrated in FIG. 14A indicates that two wireless devices ID of “54687612” and “58959562” are received by the wireless communication unit 301. Table 1410 also indicates that wireless terminal 104 corresponding to wireless device ID of “58959562” has been already authenticated for the wireless communication.

Table 1420 illustrated in FIG. 14B indicates that the wireless terminal 104, corresponding to the wireless device ID of “58959562” illustrated a dashed line 1421, leaves from the wireless communication unit 301 to the distance rage from 1 m to less than 2 m. In this case, since the radio wave intensity corresponding to the wireless device ID of “58959562” becomes “middle” (i.e., lower than the second threshold value), the wireless authentication unit 303 cancels the wireless authentication status of “authenticated” for the wireless communication set for the wireless device ID of “58959562” using the sequence illustrated in FIG. 13.

Table 1430 illustrated in FIG. 14C indicates that the wireless authentication unit 303 cancels the wireless authentication status of “authenticated” set for the wireless terminal 104 corresponding to the wireless device ID of “58959562,” indicated in a dashed line 1431, and sets the wireless authentication status of “not authenticated.”

Table 1440 illustrated in FIG. 14D indicates that the wireless terminal 104 corresponding to the wireless device ID of “58959562,” indicated in a dashed line 1441, leaves from the image forming apparatus 101 for 2 m or more.

Table 1450 illustrated in FIG. 14E indicates that no authentication information (wireless device ID) is received by the wireless communication unit 301. If this situation continues for a given time period or more, the image forming apparatus 101 shifts to the power saving mode using the sequence illustrated in FIG. 13.

As above described in the second embodiment, the image forming apparatus 101 can reduce the number of unnecessary processing by limiting situations of executing the wireless authentication processing, with which possibility of erroneous authentication can be reduced. With this configuration, the image forming apparatus 101 can further reduce the waiting time of the authentication processing, and improve or enhance the usability or operability of user.

### Third Embodiment

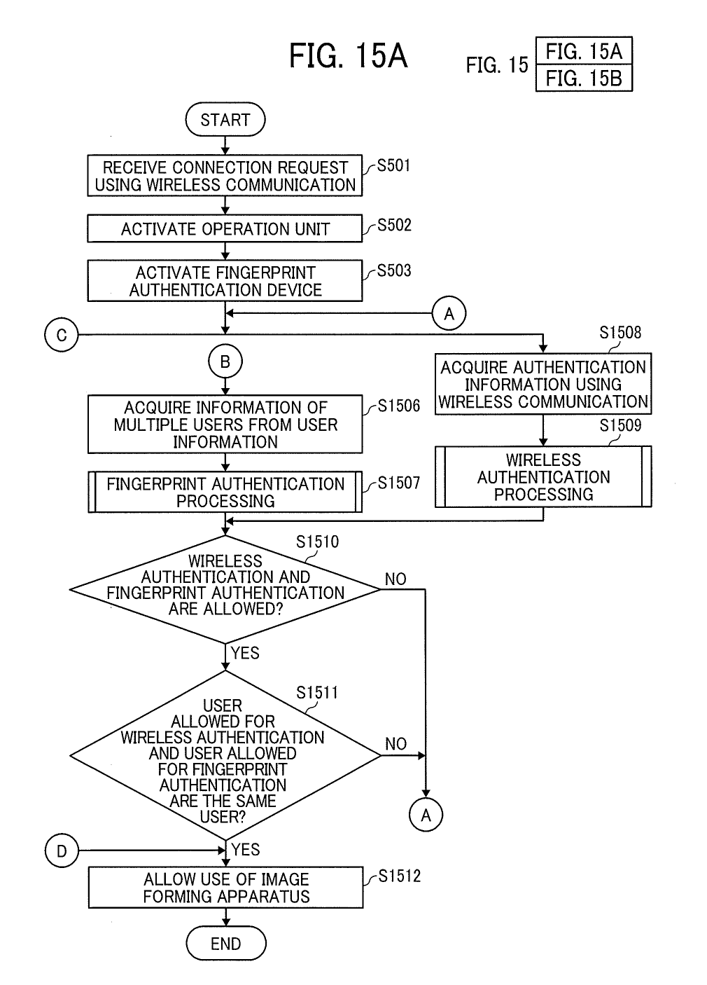

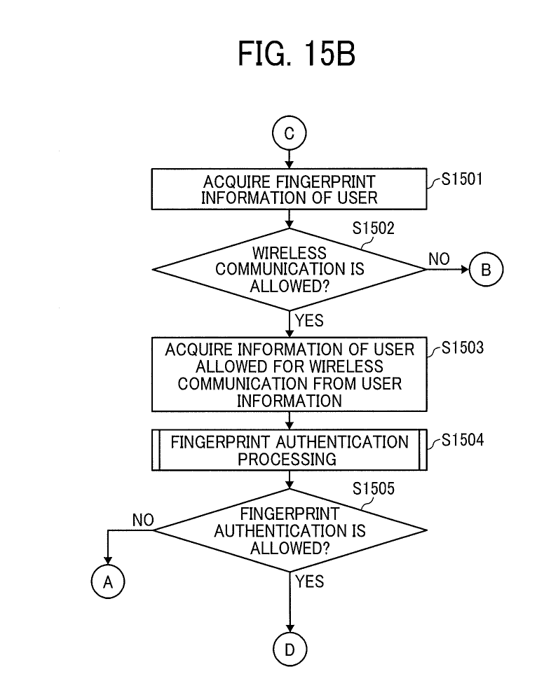

In the first embodiment and second embodiment, the fingerprint authentication processing using the fingerprint authentication unit 305 is executed after executing the wireless authentication using the wireless authentication unit 303. Hereinafter, a description is given of a third embodiment with reference to FIG. 15 (15A and 15B), in which the image forming apparatus 101 executes the wireless authentication processing using the wireless authentication unit 303 and the fingerprint authentication processing using the fingerprint authentication unit 305 in parallel.

FIGS. 15A and 15B are an example of a flowchart illustrating the steps of authentication processing of the third embodiment. Since steps S501 to S503 in FIGS. 15A and 15B are similar to that of the authentication processing of the first embodiment illustrated in FIG. 5, the difference between the first embodiment and the third embodiment is described. Further, the detailed description of the processing similar to the first embodiment may be omitted.

In the third embodiment, after the fingerprint authentication device 103 is activated in step S503, the sequence of steps S1501 to S1505 and the sequence of steps S1508 and S1509 are executed in parallel.

In step S1501, the fingerprint information acquisition unit 304 acquires fingerprint information of the user 105.

In step S1502, the fingerprint authentication unit 305 determines whether the user 105 authenticated for the wireless communication by the wireless authentication unit 303 exists.

If the user 105 whose wireless authentication is allowed or authenticated by the wireless authentication unit 303 exists (when the wireless communication of the user 105 is already authenticated) (S1502: YES), the fingerprint authentication unit 305 proceeds the sequence to step S1503. On the other hand, if the user 105 whose wireless authentication is authenticated by the wireless authentication unit 303 does not exist (when the wireless authentication of the user 105 has not been authenticated) (S1502: NO), the fingerprint authentication unit 305 proceeds the sequence to step S1506.

In step S1503, the fingerprint authentication unit 305 acquires information of user allowed or authenticated for the wireless communication, for example, from the user information 313 (user information “a”) illustrated in FIG. 4.

In step S1504, the fingerprint authentication unit 305 performs the fingerprint authentication processing, such as steps 5702 to 5709 of FIG. 7, using the fingerprint feature information included in the user information acquired in step S1503.

In step S1505, the fingerprint authentication unit 305 proceeds the sequence into different steps depending on whether the fingerprint authentication is allowed for the user 105.

If the fingerprint authentication is allowed or authenticated for the user 105 (S1505: YES), the fingerprint authentication unit 305 proceeds the sequence to step S1512. On the other hand, if the fingerprint authentication is not allowed for the user 105 (S1505: NO), the fingerprint authentication unit 305 returns the sequence to steps S1501 and S1508.

Further, when the sequence proceeds from steps S1502 to S1506, in step S1506, the fingerprint authentication unit 305 acquires information of a plurality of users such as fingerprint feature information stored in the user information 313 (user information “a”) illustrated in FIG. 4.

In step S1507, the fingerprint authentication unit 305 executes the fingerprint authentication processing, such as the fingerprint authentication processing in steps S702 to S709 of FIG. 7, for each fingerprint feature information included in the user information acquired in step S1506.

In step S1508, the wireless communication unit 301 acquires the authentication information (e.g., wireless device ID) from the wireless terminal 104 using the BLE communication.

In step S1509, the wireless authentication unit 303 executes the wireless authentication processing illustrated in FIG. 6.

In step S1510, the use control unit 306 determines whether the wireless authentication and the fingerprint authentication are allowed or authenticated by performing the processing of steps S1501 to S1509.

If the wireless authentication and the fingerprint authentication are not authenticated or allowed (S1510: NO), the use control unit 306 returns the sequence to step S1501 and S1508. On the other hand, if the wireless authentication and the fingerprint authentication are authenticated or allowed (S1510: YES), the use control unit 306 proceeds the sequence to step S1511.

In step S1511, the use control unit 306 determines whether a user who is allowed for the wireless authentication and a user who has been allowed for the fingerprint authentication are the same user. For example, the use control unit 306 determines whether the identification information (e.g., address book number) of the user notified from the wireless authentication unit 303 in step S604 (FIG. 6) matches the identification information of the user notified from the fingerprint authentication unit 305 in step S706 (FIG. 7).

If the user who is allowed for the wireless authentication and the user who is allowed for the fingerprint authentication is not the same user (S1511: NO), the use control unit 306 returns the sequence to step S1501 and S1508. On the other hand, if the user who is allowed for the wireless authentication and the user who is allowed for the fingerprint authentication are the same user (S1511: YES), the use control unit 306 proceeds the sequence to step S1512.

In step S1512, the use control unit 306 allows the use of the image forming apparatus 101 by the user 105 who is allowed or authenticated by the wireless authentication processing and the fingerprint authentication processing.

In the above described processing of the third embodiment, when the fingerprint information of a user is acquired, for example, before the wireless authentication is not yet authenticated, the fingerprint authentication processing of the user is executable ahead of the wireless authentication processing.

### Variant Example

Hereinafter, a description is given of variant examples applicable to the first to third embodiments.

### Variant Example 1 of Authentication Processing:

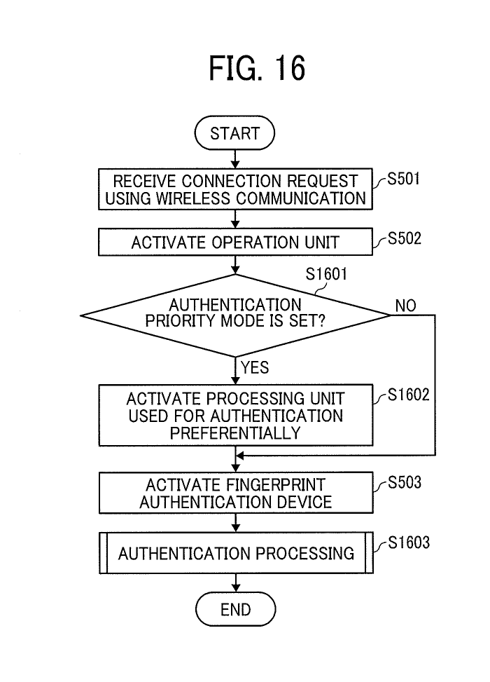

FIG. 16 is an example of a flowchart illustrating the steps of authentication processing of a variant example 1. The sequence of FIG. 16 indicates a variant example to increase the processing speed of the authentication processing of the first to third embodiments. Since steps S501, S502, and S503 of FIG. 16 are similar to those of the first to third embodiments, the difference between the variant example 1 and the first to third embodiments is described.

In step S1601, the mode control unit 302 determines whether the image forming apparatus 101 is set with an authentication priority mode.

In the variant example 1 of the image forming apparatus 101, the setting reception unit 309 displays, for example, a setting screen 1760 illustrated in FIG. 17B(2), on the operation panel 126 to receive the setting of the “authentication priority mode” by a user such as enabling and disenabling of “authentication priority mode.” The user 105 can set the authentication priority mode (authentication priority function) of the image forming apparatus 101 by selecting an “enable” button 1761 used for setting the authentication priority mode, and then selecting a “setting” button 1762 illustrated in FIG. 17B(2).

If the image forming apparatus 101 is not set with the authentication priority mode (S1601: NO), the mode control unit 302 proceeds the sequence to step S503. On the other hand, if the image forming apparatus 101 is set with the authentication priority mode (S1601: YES), the mode control unit 302 proceeds the sequence to step S1602.

In step S1602, the mode control unit 302 preferentially activates one or more processing units (e.g., wireless authentication unit 303, fingerprint authentication unit 305) used for the authentication processing.

For example, the mode control unit 302 suppresses (e.g., stops) the activation of the display input control unit 308, the setting reception unit 309, the log information management unit 310 (FIG. 3), and image forming application to be described later, but activates one or more processing units related to the authentication processing with higher priority to increase the activation speed of the authentication processing.

In step S503, the mode control unit 302 activates the fingerprint authentication device 103.

In step S1603, the operation unit 120 executes the authentication processing described in any one of the first to third embodiments. For example, the operation unit 120 executes the authentication processing of the first embodiment illustrated in steps S504 to 5510 of FIG. 5.

Since the activation of the processing units related to the authentication processing is accelerated by performing the above processing of the variant example 1, when the image forming apparatus 101 authenticates the user using the two-factor authentication processing, the waiting time of the authentication processing can be reduced, and the usability or operability of user can be improved.

### Variant Example 2 of Authentication Processing:

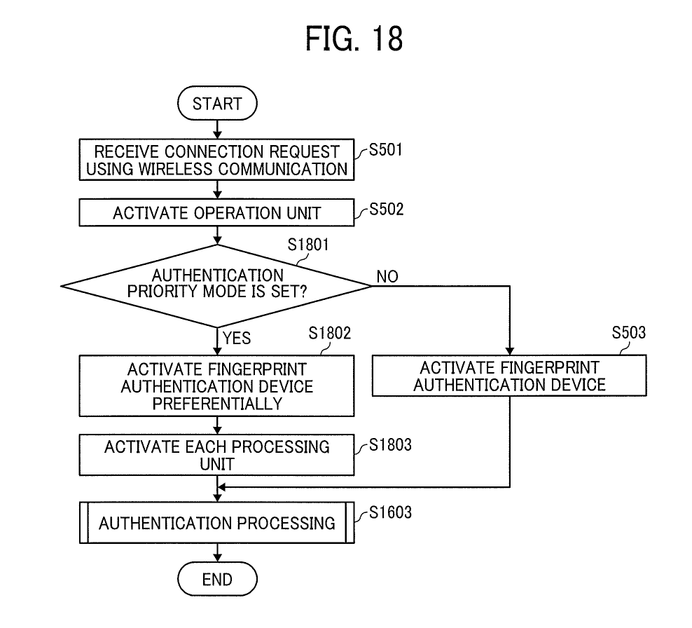

FIG. 18 is an example of a flowchart illustrating the steps of authentication processing of variant example 2. The variant example 2 illustrates another variant example to increase the processing speed of the authentication processing of the first to third embodiments. Since processing of steps S501, S502, and S503 of FIG. 18 are similar to those of the first to third embodiments, the difference between the variant example 2 and the first to third embodiments is to be described.

In step S1801, the mode control unit 302 determines whether the image forming apparatus 101 is set with the authentication priority mode.

If the image forming apparatus 101 is not set with the authentication priority mode (S1801: NO), the mode control unit 302 proceeds the sequence to step S503. On the other hand, if the image forming apparatus 101 is set with the authentication priority mode (S1801: YES), the mode control unit 302 proceeds the sequence to step S1802.

In step S1802, the mode control unit 302 preferentially activates the fingerprint authentication device 103, and then the mode control unit 302 activates each processing unit in step S1803. With this processing, for example, when a given time is required for activating the fingerprint authentication device 103 (e.g., the time required for activating the fingerprint authentication device 103 is relatively longer), the time that the user 105 recognizes as the waiting time of activating the fingerprint authentication device 103 can be shortened.

In step S1603, similar to the processing illustrated in FIG. 16, the operation unit 120 executes, for example, the authentication processing described in any one of the first to third embodiments.

Since the fingerprint authentication device 103 is preferentially activated by performing the above described processing of variant example 2, when the given time is required for activating the fingerprint authentication device 103 (e.g., the time required for activating the fingerprint authentication device 103 is relatively longer), the time that the user 105 recognizes as the waiting time of activating the fingerprint authentication device 103 can be shortened.

### Variant Example 3 of Authentication Processing:

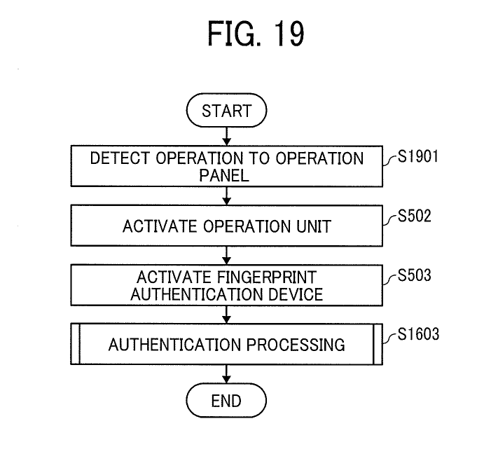

FIG. 19 is an example of a flowchart illustrating the steps of authentication processing of a variant example 3. In the above described first to third embodiments, the image forming apparatus 101 returns the operation unit 120 to the normal mode from the power saving mode in response to receiving the connection request for wireless communication by the wireless communication unit 301. However, the image forming apparatus 101 can be configured to return the operation unit 120 to the normal mode from the power saving mode using another trigger.

For example, the mode control unit 302 can be configured to activate the operation unit 120 in step S502 (FIG. 5) when the mode control unit 302 detects an operation (e.g. touching) to the operation panel 126 in step S1901 of FIG. 19.

As above described, the mode control unit 302 can be configured to activate the operation unit 120 using the trigger different from the reception of the connection request for wireless communication by the wireless communication unit 301. Further, since the image forming apparatus 101 authenticates the user using the two-factor authentication processing using the methods described in the first to third embodiments after the operation unit 120 is activated, the waiting time of the authentication processing can be reduced, and thereby the usability or operability of user can be improved or enhanced.

### Acquiring of Log Information:

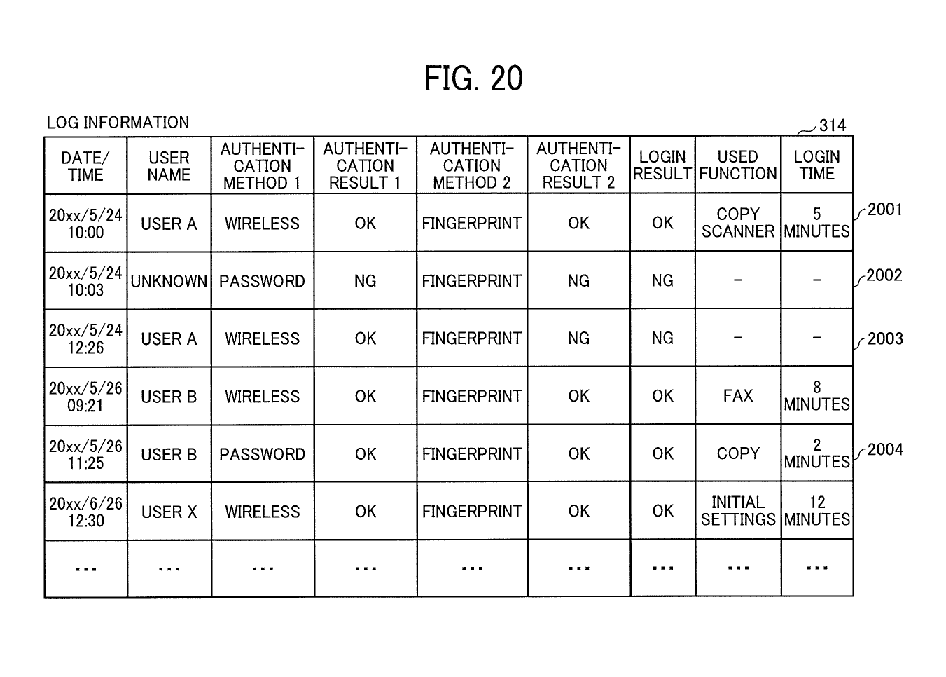

When the authentication processing is executed, the log information management unit 310 of the operation unit 120 preferably acquires log information 314 illustrated in FIG. 20, and stores the log information 314 in the storage unit 312. In an example case of FIG. 20, the log information 314 includes information, such as “date/time,” “user name,” “authentication method 1,” “authentication result 1,” “authentication method 2,” “authentication result 2,” “login result,” “used function,” and “login time.”

The “date/time” indicates date and time when the authentication processing was performed. The “user name” indicates a name of a user who was received the authentication processing.

The “authentication method 1” indicates a first authentication method of the executed two-factor authentication processing. The “authentication result 1” indicates an authentication result of the first authentication method of the executed two-factor authentication processing. The “authentication method 2” indicates a second authentication method of the executed two-factor authentication processing. The “authentication result 2” indicates an authentication result of the second authentication method.

The “login result” indicates whether each user was allowed to use the image forming apparatus 101 (or whether the user succeeded in the log-in). The “used function” indicates a function used by each user. The “log-in time” indicates the time period when each user logged in the image forming apparatus 101.

In an example of FIG. 20, log 2001 indicates an example of a log when the wireless authentication and the fingerprint authentication of the user 105 having a user name of “User A” were allowed, and the user A used the copy and scanner functions.

Log 2002 indicates an example of a log when the user 105, having unknown name, failed the password authentication and the fingerprint authentication. In this case, it is assumed that the user 105, having unknown name, may not be allowed to use the image forming apparatus 101, and not be registered in the user information 313 (user information “a”) illustrated in FIG. 4.

Log 2003 indicates an example of a log when the user 105 having the user name of “User A” succeeded in the wireless authentication but failed the fingerprint authentication. In this case, for example, it is assumed that a third party attempted to log in using the wireless terminal 104 of the user 105 having the user name of “User A,” or it is assumed that the fingerprint feature information registered in the user information 313 needs to be updated. Log 2004 indicates an example of a log that the user 105 having the user name of

“User B” used the image forming apparatus 101 by performing the wireless authentication processing and the fingerprint authentication processing two hours before, and then the user B used the image forming apparatus 101 again by performing the password authentication processing and fingerprint authentication processing. In the case of log 2004, for example, it is assumed that a problem occurred for the user B such as the user B lost the wireless terminal 104, the wireless terminal 104 was out of battery, or the wireless terminal 104 malfunctioned.

As described above, by acquiring and storing the log information 314 illustrated in FIG. 20 in the storage unit 312, the administrator of the image forming apparatus 101 can analyze the status of the authentication of each user 105.

### Software Configuration:

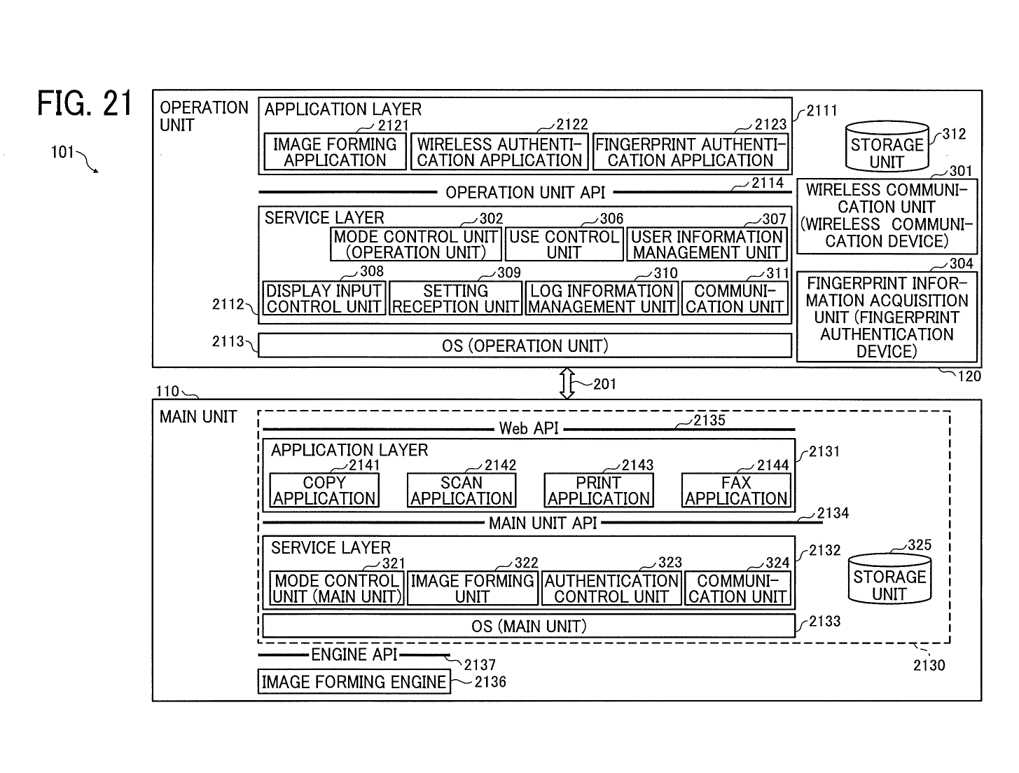

Hereinafter, a description is given of an example of a software configuration of the image forming apparatus 101 with reference to FIG. 21.

FIG. 21 illustrates an example of a software configuration of the image forming apparatus 101 of the above described embodiments.

### Software Configuration of Operation Unit:

As illustrated in FIG. 21, the operation unit 120 includes, for example, an application layer 2111, a service layer 2112, and an OS 2113. By executing one or more programs using the CPU 121 (FIG. 2), the operation unit 120 implements each functional unit illustrated in FIG. 21.

The application layer 2111 is an application program (hereinafter, “application”) providing various functions, such as an image forming application 2121, a wireless authentication application 2122, and a fingerprint authentication application 2123.

the image forming application 2121 is an application used for performing various functions, such as copying, scanning, printing, and facsimile communication provided by the image forming apparatus 101.

The wireless authentication application 2122 is an application used for performing the wireless authentication processing. The operation unit 120 executes the wireless authentication application 2122, for example, to implement the wireless authentication unit 303 illustrated in FIG. 3.

the fingerprint authentication application 2123 is an application used for performing the fingerprint authentication processing. The operation unit 120 executes the fingerprint authentication application 2123 to implement, for example, the fingerprint authentication unit 305 illustrated in FIG. 3.

The service layer 2112, set between the application layer 2111 and the OS 2113, is used as an interface for providing various functions set in the image forming apparatus 101 to the application layer 2111. Each application installed in the application layer 2111 can use the functions provided by the service layer 2112 using an operation unit application interface (API) 2114.

The service layer 2112 includes, for example, the mode control unit 302, the use control unit 306, the user information management unit 307, the display input control unit 308, the setting reception unit 309, the log information management unit 310, and the communication unit 311 illustrated in FIG. 3. The operation unit 120 executes one or more programs (e.g., system application) to implement the mode control unit 302, the use control unit 306, the user information management unit 307, the display input control unit 308, the setting reception unit 309, the log information management unit 310, and the communication unit 311.

The OS 2113 is a basic software such as an operating system for providing basic functions provided in the operation unit 120. The service layer 2112 converts a usage request of hardware resources from each application into a command that can be interpreted by the OS 2113, and transfers the command to the OS 2113. When the command is executed by the OS 2113, the hardware resources perform an operation in accordance with the request of the application.

The OS 2113 also controls other units, such as the storage unit 312, the wireless communication device 102, and the fingerprint authentication device 103. The wireless communication device 102 includes, for example, a microcomputer, and the wireless communication unit 301 illustrated in FIG. 3 is implemented by executing one or more programs using the microcomputer of the wireless communication device 102.

Similarly, the fingerprint authentication device 103 includes, for example, a microcomputer, and the fingerprint information acquisition unit 304 illustrated in FIG. 3 is implemented by executing one or more programs using the microcomputer of the fingerprint authentication device 103.

### Software Configuration of Main Unit:

As illustrated in FIG. 21, the main unit 110 includes, for example, an application layer 2131, a service layer 2132, an OS 2133 indicated in a broken line section 2130, and an image forming engine 2136. The main unit 110 implements the application layer 2131, the service layer 2132, and the OS 2133 when the CPU 111 (FIG. 2) executes one or more programs. Further, the image forming engine 2136 is implemented by, for example, executing one or more programs using a microcomputer included in the engine unit 117 (FIG. 2).

The application layer 2131 is an application used for providing one or more functions, and includes, such as a copy application 2141, a scan application 2142, a print application 2143, and a facsimile (FAX) application 2144. Each application installed in the application layer 2111 can be used, for example, from the image forming application 2121 of the operation unit 120 using a Web API 2135.

The service layer 2132, set between the application layer 2131 and the OS 2133, is used as an interface for providing various functions of the image forming apparatus 101 to the applications installed in the application layer 2131, the operation unit 120, and the like. Each application installed in the application layer 2131 can use the functions provided by the service layer 2132 using a main unit API 2134.

The service layer 2132 includes, for example, the mode control unit 321, the image forming unit 322, the authentication control unit 323, and the communication unit 324 illustrated in FIG. 3. For example, by executing one or more programs, the main unit 110 implements the mode control unit 321, the image forming unit 322, the authentication control unit 323, and the communication unit 324.

The mode control unit 321 controls the power supply mode (e.g., power saving mode, normal mode) of the operation unit 120 and the main unit 110 as described above. The image forming unit 322 controls the image forming engine 2136 using an engine API 2137, and executes an image forming function (e.g., printing, copying, scanning, facsimile) provided in the image forming apparatus 101.

The authentication control unit 323 controls the authentication processing of the main unit 110. For example, if the use of the image forming apparatus 101 by the user 105 is allowed by the use control unit 306 of the operation unit 120, the authentication control unit 323 allows the user 105 to use the image forming function of the main unit 110.

The communication unit 324 of the main unit 110 is communicably connected to the communication unit 311 of the operation unit 120, for example, by a USB over internet protocol (IP), and performs communication such as hypertext transport protocol (HTTP) communication between the operation unit 120 and the main unit 110.

The OS 2133 is a basic software providing basic functions for controlling hardware resources disposed in the main unit 110. The service layer 2132 converts a usage request of hardware resources from each application into a command that can be interpreted by the OS 2133, and transfers the command to the OS 2133. When the command is executed by the OS 2133, the corresponding hardware resources perform an operation in accordance with the request of the application.

In the above described embodiments, the OS 2133 of the main unit 110 and the OS 2113 of the operation unit 120 are operated using different OSs.

For example, the OS 2133 of the main unit 110 uses a first operating system, such as Linux (registered trademark) or NetBSD (registered trademark) while the OS 2113 of the operation unit 120 uses a second operating system, such as a power saving OS using Android (registered trademark).

Therefore, the communication between the main unit 110 and the operation unit 120 is different from the communication between the normal communication. For example, the communication between the main unit 110 and the operation unit 120 use HTTP communication as described above.

As to the above described embodiments of the information processing system that authenticates a user using the two-factor authentication processing, the complexity of authentication processing and the increase in the waiting time required for the authentication processing can be reduced, thereby enhancing usability or operability of users. In the above described embodiments, the execution apparatus is the main unit 110 of the image forming apparatus 101, but the execution apparatus is not limited thereto. For example, the execution apparatus can be any apparatus or machine that executes a specific work, such as industrial machines used in factories.

Although the description of the present invention has been made based on the embodiments described above, the present invention is not limited to the requirements described in the above embodiments. Numerous additional modifications and variations are possible in light of the above teachings. It is therefore to be understood that, within the scope of the appended claims, the disclosure of this patent specification may be practiced otherwise than as specifically described herein.

Each of the functions of the above described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

1. What is claimed is:

1. A system comprising:
a wireless communication device to perform wireless communication with a wireless terminal carried by a user;
a biometric authentication device to acquire biometric information of the user carrying the wireless terminal to perform a biometric authentication of the user;
an information processing apparatus, connected to the wireless communication device and the biometric authentication device, including circuitry to
shift the information processing apparatus and the biometric authentication device each from a normal mode in which one or more processing are executable, to a power saving mode in which power consumption is set lower than power consumption during the normal mode, when a mode shifting condition is satisfied;
activate the information processing apparatus and the biometric authentication device in response to a detection of the wireless terminal by the wireless communication performed between the wireless communication device and the wireless terminal during the power saving mode;
perform wireless authentication processing for the user carrying the wireless terminal based on authentication information received by the wireless communication device from the wireless terminal using the wireless communication;
perform the biometric authentication processing for the user using first biometric feature information of the user registered in advance, and second biometric feature information of the user acquired by using the biometric authentication device in response to authentication of the wireless authentication of the user; and
allow the user to use an execution apparatus disposed in the system in response to authentication of the user by the wireless authentication processing and the biometric authentication processing.

2. The system of claim 1,
wherein the biometric authentication device is a fingerprint authentication device that acquires fingerprint information of one or more fingers of the user as the biometric information of the user when the user places the one or more fingers of the user on the biometric authentication device or proximity to the biometric authentication device without contacting the one or more fingers of the user on the biometric authentication device.

3. The system of claim 1,
wherein the wireless communication device performs a short-range wireless communication with the wireless terminal when the wireless terminal is within a given range from the wireless communication device using Bluetooth (registered trademark) low energy communication.

4. The system of claim 1,
wherein the circuitry performs the wireless authentication processing for the user carrying the wireless terminal when radio wave intensity received by the wireless communication device from the wireless terminal using the wireless communication is equal to or greater than a first threshold value.

5. The system of claim 4,
wherein when the radio wave intensity received by the wireless communication device from the wireless terminal carried by the user becomes less than a second threshold after the user is allowed to use the execution apparatus disposed in the system, the circuitry disconnects the wireless communication between the wireless communication device and the wireless terminal carried by the user to prohibit the user from using the execution apparatus disposed in the system.

6. The system of claim 1,
wherein the circuitry previously registers, as user information, the authentication information of the user and the biometric feature information of the user,
wherein when the authentication information, received by the wireless communication device from the wireless terminal using the wireless communication, matches the authentication information registered in the user information, the circuitry authenticates the wireless authentication of the user.

7. The system of claim 6,
wherein after the circuitry authenticates the wireless authentication of the user, the circuitry performs the biometric authentication processing of the user using the biometrics feature information of the user, authenticated by the wireless authentication processing, registered in the user information.

8. The system of claim 6,
wherein if the wireless authentication of the user is not yet authenticated by the circuitry, the circuitry performs the biometric authentication processing of the user using a plurality items of the biometric feature information registered in the user information.

9. The system of claim 8,
wherein when the user authenticated by the biometric authentication processing and the user authenticated by the wireless authentication processing are the same user, the circuitry allows the user to use the execution apparatus disposed in the system.

10. The system of claim 1,
wherein, in activating the information processing apparatus and the biometric authentication device, the circuitry is configured to activate one or more functions related to the wireless authentication processing and the biometric authentication processing with a higher priority.

11. The system of claim 10,
wherein the circuitry activates the one or more functions related to the wireless authentication processing and the biometric authentication processing with the higher priority compared to other processing when the wireless authentication processing and the biometric authentication processing are set with the higher priority.

12. The system of claim 10,
wherein the circuitry activates the biometric authentication device with the higher priority compared to other device when the wireless authentication processing and the biometric authentication processing are set with the higher priority.

13. The system of claim 10,
wherein the circuitry is configured to set with a selection of enabling setting of the higher priority of the wireless authentication processing and the biometric authentication processing, or a selection of disenabling setting of the higher priority of the wireless authentication processing and the biometric authentication processing.

14. The system of claim 1,
wherein the execution apparatus is connected to the information processing apparatus and configured to perform image processing,
wherein after the circuitry activates the information processing apparatus and the biometric authentication device in response to the detection of the wireless terminal by the wireless communication performed between the wireless communication device and the wireless terminal during the power saving mode, the circuitry activates the execution apparatus when the user, allowed to use the execution apparatus disposed in the system, is to use the execution apparatus to perform the image processing.

15. The system of claim 1,
wherein the circuitry stores log information associating an authentication result of the wireless authentication processing, an authentication result of the biometric authentication processing, and a use status related to the system in a memory.

16. The system of claim 1, further comprising an operation panel configured to receive an operation by the user, and when the operation panel receives the operation performed by the user during the power saving mode, the circuitry activates the information processing apparatus and the biometric authentication device.

17. The system of claim 1,
wherein the biometric authentication device is a vein authentication device that acquires vein information of the user carrying the wireless terminal as the biometric information of the user when the user contacts a finger or a palm of the user on the vein authentication device or approaches the finger or the palm of the user proximity to the vein authentication device without contacting the finger or the palm of the user on the vein authentication device.

18. An image processing apparatus comprising:
a wireless communication device to perform wireless communication with a wireless terminal carried by a user;
a biometric authentication device to acquire biometric information of the user carrying the wireless terminal to perform biometric authentication of the user;
an execution apparatus to execute image processing; and
an operation apparatus connected to the wireless communication device, the biometric authentication device, and the execution apparatus, the operation apparatus including circuitry to
activate the operation apparatus and the biometric authentication device in response to a detection of the wireless terminal by the wireless communication performed between the wireless communication device and the wireless terminal during a power saving mode, power consumption during the power saving mode being set lower than power consumption during a normal mode that one or more processing are executable;
perform wireless authentication processing for the user carrying the wireless terminal based on authentication information received by the wireless communication device from the wireless terminal using the wireless communication;
perform the biometric authentication processing for the user using first biometric feature information of the user registered in advance, and second biometric feature information of the user acquired by using the biometric authentication device in response to authentication of the wireless authentication of the user; and
allow the user to use the execution apparatus in response to authentication of the user by the wireless authentication processing and the biometric authentication processing.

19. A method of controlling an authentication of a user in a system including a wireless communication device to perform wireless communication with a wireless terminal carried by the user, and a biometric authentication device to acquire biometric information of the user carrying the wireless terminal to perform biometric authentication of the user, the method comprising:
activating the biometric authentication device in response to a detection of the wireless terminal by the wireless communication performed between the wireless communication device and the wireless terminal during a power saving mode, power consumption during the power saving mode being set lower than power consumption during a normal mode that one or more processing are executable;
performing wireless authentication processing for the user carrying the wireless terminal based on authentication information received by the wireless communication device from the wireless terminal using the wireless communication;
performing the biometric authentication processing for the user using first biometric feature information of the user registered in advance, and second biometric feature information of the user acquired by using the biometric authentication device in response to authentication of the wireless authentication of the user; and
allowing the user to use an execution apparatus disposed in the system in response to authentication of the user by the wireless authentication processing and the biometric authentication processing.
